(19) United States
(12) Patent Application Publication
(10) Pub. No.: US 2013/0036983 A1
(43) Pub. Date: Feb. 14, 2013

(54) Method and System for Mass Production of Fish Embryos

(71) Applicants: Isaac Adatto, Jamaica Plain, MA (US); Christian Lawrence, Plympton, MA (US)

(72) Inventors: Isaac Adatto, Jamaica Plain, MA (US); Christian Lawrence, Plympton, MA (US)

(73) Assignee: CHILDREN'S MEDICAL CENTER CORPORATION, Boston, MA (US)

(21) Appl. No.: 13/574,495

(22) PCT Filed: Jan. 20, 2011
(86) PCT No.: PCT/US2011/021880

§ 371 Date: Oct. 5, 2012

Related U.S. Application Data
(60) Provisional application No. 61/296,628, filed on Jan. 20, 2010.

(51) Int. Cl. A01K 61/00; A01K 63/00

(52) U.S. Cl. 119/217; 119/225

(57) ABSTRACT

A method and system for producing large quantities of aquatic animal embryos includes providing a water filled spawning tank adapted for holding the male and female aquatic animals in various configurations. The system can include a spawning platform which includes a porous or perforated element that allows the embryos but not the aquatic animal to pass through and a separator which includes a porous or perforated element that can be used to separate the male aquatic animals from the female aquatic animals during a priming phase. In operation, the spawning platform can be placed in the bottom of the tank in order to provide a bottom collection area where the embryos can be collected and the aquatic animals cannot eat or otherwise harm the embryos. The female aquatic animals can be placed in tank above the spawning platform. The separator can be placed in the tank above the female aquatic animals and the male aquatic animals can be placed in the tank above, remaining separated from the female aquatic animals, beginning the priming phase. When embryos are desired, the separator can be removed allowing the male aquatic animals to mingle with the female aquatic animals and the height of the water above the porous or perforated element of the spawning platform can be changed, by raising the spawning platform or lowering the water level, in the spawning phase. The porous or perforated element of the spawning platform can be undulating or angled with respect to horizontal to create areas of varying depth over the surface of the porous or perforated element of the spawning platform to improve embryo production.

### CROSS REFERENCE TO RELATED APPLICATIONS

This application claims the benefit under 35 U.S.C. §119(e) of U.S. Provisional Patent Application No. 61/296,628 filed 20 Jan. 2010, which is incorporated fully herein by reference.

### GOVERNMENT SUPPORT

This invention was made with US Government support under contract(s) 5PO1HL32262 and 2P30 DK49216 awarded by the US National Institutes of Health. The US Government may have certain rights in this invention.

### FIELD OF THE INVENTION

The present invention relates to the reproductive biology and spawning of aquatic animals. More specifically, embodiments of the present invention provide for methods, apparatuses, and kits for increased production of fish embryos. The present invention is directed to devices, systems, methods and, kits that can provide high volume production of zebrafish embryos in an efficient manner. One advantage of the present invention is that large volumes of developmentally synchronized embryos can be produced, which allows for a substantially shorter time in which experimental results may be achieved.

### BACKGROUND OF THE INVENTION

Zebrafish (Danio rerio) models are useful in a wide range of biological studies aimed at elucidating the nature of human development and disease. In particular, there is growing demand for new, robust and cost-effective ways to assess chemicals for their effect on human health, particularly during early development. Because traditional mammalian models for toxicology are both expensive and difficult to work with during embryonic stages, zebrafish models are becoming an increasingly viable alternative.

The experimental advantages of zebrafish include their small size, rapid external development, optical transparency during early development, permeability to small molecules, amenability to high throughput screening, genetic similarity to humans, and a growing array of suitable tools and methods. Further, their great fecundity, which allows for individual clutch sizes in excess of seven hundred embryos, enables high throughput screening and an increased statistical power for experiments. This tremendous reproductive potential is unmatched by any other major vertebrate model organism, and make zebrafish embryo and larvae particularly suitable for use in studies where a high throughput rate and automation are advantageous. Exploitation of these traits is dependent upon sound management of laboratory breeding stocks, which must be grounded in a thorough understanding of the reproductive biology and behavior of the animal. However, the methods and equipment typically used to collect newly spawned zebrafish embryos in the laboratory do not allow this potential to be fully realized.

There are currently two broad categories of strategy for spawning of laboratory zebrafish breeding stocks. In-tank based strategies provide a spawning site or substrate directly in the holding tanks, while the fish remain “on system” or in flow. Improvements on this basic approach are limited by their unpredictability and inflexibility to various modes of experimental design. Alternatively, static tank strategies involve removing the fish from their holding tanks and spawning them in off-system or “static water” breeding chambers. Static tank strategies are susceptible to decreasing water quality over time, constant handling, and are labor and space intensive when large numbers of embryos are needed for experiments.

Thus, there is a need for a zebrafish spawning and embryo collection system that capitalizes on the natural tendency of zebrafish to spawn in shallow water, along an undulating gradient of shallow and deeper zones, in order to promote consistent production of very large numbers of embryos in short time periods with greatly reduced space and labor requirements. Further, the present invention allows for the rapid collection of tightly developmentally synchronized embryos and the completion of experiments in days to weeks instead of months.

### Previous Approaches to Zebrafish Embryo Production

Previous approaches to zebrafish embryo spawning can generally be divided into in-tank based strategies and static tanks based strategies. These approaches are not efficient because they are not premised in the environmental and behavioral preferences of zebrafish spawning in the wild.

In-Tank Strategies: In-tank based strategies involve simply providing a spawning site or substrate directly in the holding tanks, while the fish remain “on system” or in flow. This type of technique relies on the “natural” production of fish kept in mixed sex groups with minimal manipulation of individuals. Another important feature of this basic approach is that because fish remain on flow, water quality is regulated and maintained throughout breeding events. Finally, the handling of fish, which can be a stressful event, is largely minimized.

The first formally described technique for breeding laboratory zebrafish is the most basic example of an in-tank breeding method. In this approach, glass marbles are placed at the bottom of holding tanks to provide a spawning substrate for the animals. Fish spawn over the marbles, and the embryos drop into the spaces in between, preventing embryo cannibalism and facilitating their subsequent collection by siphoning (29-30). While this method may be effective to some extent, it is generally impractical for use in large culturing facilities with hundreds or thousands of tanks.

A slightly more advanced in-tank approach involves placing a breeding box or container in holding tanks that fish will spawn over during a breeding event. A common feature of this method is that the box or container will have a mesh-type top through which spawned embryos drop and are subsequently protected from cannibalism. The box will also typically have some plastic plants affixed to it to make it more attractive as a spawning site. This type of method is more facile than the marbles based technique, as boxes can be moved freely in and out of holding tanks as desired. It also better facilitates the collection of staged embryos from groups of fish, and can also be used for breeding pairs.

Another form of in-tank breeding involves the use of a specially manufactured crossing cage that is designed to fit inside holding tanks. The fish to be crossed are netted out of holding tanks and transferred to the crossing cage. Embryos are collected after breeding takes place by siphoning or after removal of the fish from the tank. This method allows for production of time-staged embryos because it can include a divider to separate males and females until embryos are needed for experiments. This technology has a number of drawbacks, including the fact that all fish in the housing tanks where breeding is taking place must be either in the crossing cage or transferred to other tanks so that embryos are not cannibalized. This requires extensive handling of animals, offsetting one inherent advantage of the in-tank breeding methodology. Secondly, in most cases, flow of clean water into tanks must be either shut off or reduced to prevent spawned embryos from being flushed out of the tanks. There may be means by which to collect these embryos when flow remains on, but if not, another strength of the in-tank system is taken away when using this method.

The most recent development in in-tank breeding technology is the Mass Embryo Production System (MEPS™), designed by Aquatic Habitats, an aquatic animal housing system manufacturer. The MEPS™ is a large spawning vessel, with a holding capacity of 80 or 250 liters, which can be plumbed directly into any existing recirculatnig or flow through system. The MEPS™, which can house large populations (up to 1000 or more) of breeding fish, contains one or more spawning platforms, which are specially fabricated funnels capped with plastic mesh screens that can be located at various depths inside the vessel. When the spawning platforms are placed inside the vessel, fish breed over and on the platforms, and spawned embryos fall through the mesh into the associated funnels. The embryos are then pumped through an attached tube into separate collection screens by means of pressurized air directed into the funnels, allowing embryos to be collected without disturbing the fish. The units also have the capability to be run on altered photoperiods via the use of an attached light-cycle dome with a programmable light-cycle dimmer.

The MEPS™ system capitalizes upon several attributes of the general in-tank breeding approach, including consistent water quality and minimal handling of animals, with the added benefits of reduced labor input and increased space efficiency. When used properly, this technology is capable of supporting high-level embryo production on the order of tens of thousands of embryos per event, and is therefore well suited for experimental applications requiring large numbers of time-staged embryos. However, this approach is not without its limitations and specific challenges. For example, its use is limited to experiments where the individual identity of parents is not necessary, which excludes it from being used for certain types of genetic screens, which are an important component of the zebrafish model system. The performance of fish in this type of breeding unit is also very dependent upon management. Detailed understanding of reproductive behavior and biology of the fish is imperative to maximize efficiency, and therefore the MEPS™ may be less suitable for newly established zebrafish laboratories where such expertise is not available.

Static Tank Strategies: Static tank strategies involve removing fish from holding tanks and spawning them in an off-system or “static water” breeding chamber. This general approach, which is utilized in the great majority of zebrafish breeding facilities, adheres to the following general principles: a small (typically <1 L) plastic mating cage or insert with a mesh or grill bottom is placed inside a slightly larger container that is filled with water. Fish (pairs or small groups) are then added to the insert in the evening. When the fish spawn, the fertilized embryos fall through the “floor” of the insert and are thereby protected from cannibalism by adults (31).

This technique has proven to be generally effective and, consequently, derivations of the static tank design are manufactured by a number of aquaculture and laboratory product supply companies. Available products vary slightly in size, shape, depth, and total volume, as well as adjustability of inserts in the static spawning chamber. A very small number of studies have explored the effects of variations of these parameters on reproductive success and spawning efficiency. Sessa and colleagues (25) showed that fish set up in crossing cages in which spawning inserts were tilted to provide a deep to shallow water gradient showed statistically significant increases in embryo production when compared with fish set up in cages in which the inserts were not tiled (no gradient). Fish that were set up in chambers with tilted inserts displayed both a preference to spawn in shallow water and specific breeding behaviors that were limited to the tilted physical configuration.

Little else has been published in this area, although a study of the effects of varying the size of the breeding insert itself on spawning success and embryo production showed no difference in spawning success between control cage of 3.5 L and test cages of 500, 400, 300, 200, and 100 ml, and reduced production in 200 and 100 ml sizes (32). However, since this particular study was conducted in recirculating water (test chambers were placed inside large on-system tanks), it does not present a clear picture of the effect of chamber size on breeding efficiency in static tanks.

There are a number of strengths to the static tank approach. Virtually any type of experiment can be supported using this technique, as fish of any desired genotype can be set up in pairs or smaller groups in a varying number of crosses. Because fish are removed from holding tanks, the effects of behavioral hierarchies established in holding tanks that can be counterproductive to breeding are negated. Static tank technologies also allow for direct manipulation of water quality parameters; changes in water chemistry, such as decreases in salinity, pH, and temperature that are thought to promote spawning in fish adapted to monsoonal climate regimes (33). These factors may also affect reproduction in zebrafish.

However, there are drawbacks to static tank breeding strategies. Because the chambers are off-flow, water quality conditions in the spawning setups deteriorate over time. Although this has not been formally investigated, metabolites such as total ammonia, nitrogen and carbon dioxide accumulate in the water and are likely to have a negative effect on spawning. Tanks may be flushed with fresh water to offset these potential problems, but this represents added labor. Using static setups also necessitates that fish are handled constantly, which may be a source of long-term stress for breeding populations. Finally, although it is possible to support experiments requiring large numbers of embryos using current static breeding technologies, it is both labor and space intensive to do so, especially when compared with in-tank breeding technologies.

The drawbacks to in-tank based strategies include unpredictability as a result of poor alignment with biological realities of reproductive behavior and the necessity for sophisticated management. In-tank strategies are also marked by their inflexibility with respect to experimental design. Alternatively, the drawbacks to static tank based systems include excessive fish handling, deteriorating water conditions, a large footprint, and labor requirements on the part of a laboratory caretaker. These drawbacks, to both in-tank and static tank approaches, lend instability to experimentation and hinder the full realization of the potential of zebrafish models as tools for research.

### SUMMARY

The present invention is directed to methods, apparatuses and kits for the mass production of developmentally synchronized aquatic animal embryos (e.g., zebrafish embryos) by exploiting their environmental and behavioral spawning. Those skilled in the art will recognize that embryos from other fish that prefer to spawn in shallow water can also be produced according to the methods, apparatuses and kits described herein.

One aspect of the invention includes a method for mass producing zebrafish embryos, comprising the steps of:
(i) providing both sexes of a fish species in the same tank in a priming water profile, which is characterized by having a deeper water depth relative to the spawning water profile;
(ii) providing both sexes of the fish species in a spawning water profile, which is characterized by having a shallower depth relative to the priming water profile; and
(iii) collecting the embryos.

In some embodiments of the method, a fish impermeable, embryo permeable spawning platform is located between the fish and the embryo deposition site while the fish are in the spawning water profile.

In some embodiments of the method, each sex of fish is sequestered from the other sex, while in the priming water profile, until the initiation of spawning. In some embodiments of the invention, each sex of the fish is separated in the same tank such that the fish can detect the presence of the opposite sex using visual senses, auditory or vibration senses or olfactory senses.

In some embodiments of the invention, the fish include zebrafish.

A second aspect of the invention includes an apparatus for the mass production of fish embryos comprising:
(i) a vessel providing sufficient depth for holding zebrafish in a priming water profile; and;
(ii) a depth adjustable spawning platform for changing the water profile to a spawning water profile by raising said platform.

A third aspect of the invention includes a kit for the mass production of zebrafish embryos comprising:
(i) at least one vessel of sufficient depth for holding zebrafish in a priming water profile;
(ii) at least one vessel of sufficient depth for holding zebrafish in a spawning water profile; and
(iii) a removable spawning platform for transferring fish from a priming water profile vessel to a spawning water profile vessel.

In some embodiments, the spawning water platform can include an embryo permeable and fish impermeable bottom surface, allowing the embryos to become separated from and protected from the fish.

In some embodiments of the methods, apparatuses, and kits, the spawning platform is zebrafish impermeable and embryo permeable. In some embodiments, the spawning platform is comprised of mesh. In some embodiments, the spawning platform has an undulating topography of shallow and deeper zones. In some embodiments, the spawning platform is tilted or slanted along a consistent axis from one side of the vessel to the other side. In some embodiments, the spawning platform is adequate for safely transporting zebrafish from one vessel to another vessel.

In some aspects of the methods, apparatuses and kits of the invention, a separator platform is utilized to sequester males and females from each other while in the priming water profile until the initiation of spawning. In some embodiments, the separator platform is see-through. In some embodiments, the separator platform is comprised of a perforated material. In some embodiments, the separator platform is comprised of mesh.

In some embodiments, a water permeable, embryo impermeable, embryo collector is located between the zebrafish and an embryo deposition site. In some embodiments, the embryos are deposited by gravity. In some embodiments, water pressure is applied to the vessel walls to prevent the embryos from adhering to the vessel walls. In some embodiments, the embryo collector is comprised of mesh.

In some embodiments, the invention is employed in a rack system or multiple rack systems. In some embodiments, multiple vessels of varying sizes are employed as part of a rack system or multiple rack systems.

In one non-limiting embodiment, a vessel is round or oval.

In some embodiments of the methods, apparatuses and kits described herein a vessel with an opaque interior and a light source to manipulate the timing of spawning is employed.

In some embodiments, a continuous or interval based flow system is employed so that there is ingress of waste free water and egress of waste water.

In some embodiments of the methods, apparatuses and kits utilize a vessel adapted to hold 0-50 liters of water is utilized to create at least a priming water profile. In some embodiments, a vessel adapted to hold 50-100 liters is utilized. In some embodiments, the vessel is adapted to hold 100-200 liters. In some embodiments, the vessel is adapted to hold more than 200 liters.

In some embodiments of the methods, apparatuses and kits, a vessel capable of fitting on a flat surface such as, but not limited to, a desktop or table top is utilized.

In some embodiments, the method is practiced in an indoor or outdoor pool, lake, or naturally occurring body of water, or a manmade body of water designed to replicate a naturally occurring body of water.

In some embodiments of the methods, apparatuses and kits described herein, steps of the method or operations of the apparatus or kit may be automated.

### DESCRIPTION OF THE DRAWINGS

FIG. 1 shows a graph demonstrating the enhanced embryo production of zebrafish isolated within a spawning water profile, characterized by shallow depth and an undulating topography. Male and female zebrafish were allowed to mix overnight within a priming water profile, characterized by a greater depth than the spawning water profile. The following morning, an embryo count was made. The fish were then isolated within the spawning water profile and an embryo count was made after the first and second hour respectively. Isolation within a shallow water profile with an undulating topography resulted in a greater than 2-fold increase in embryo production in the first hour relative to the number of embryos produced during the entire night of isolation within the priming water profile. A greater than 2-fold decrease was seen in embryo production for the second hour relative to the first hour of isolation within the spawning water profile.

FIG. 2 shows a graph of embryo production, using the apparatus shown in FIGS. 4, 5A-5C according to the invention, within the first ten minutes of isolation within the spawning water profile after overnight isolation within the priming water profile. Male and female zebrafish were allowed to mix overnight within the priming water profile. An embryo count was made after the first ten minutes of six (or five, depending on which graph is used) separate spawning events.

FIG. 3 shows a graph of embryo production, using the apparatus shown in FIGS. 7A-7D according to the invention, for nine different strains of zebrafish for the first ten minutes after isolation within the spawning water profile. Male and female zebrafish were sequestered from each other overnight while isolated within the priming water profile. At the initiation of spawning, males and females were allowed to mix and isolated within the spawning water profile. An embryo count was made after the first ten minutes of spawning.

FIG. 4 shows a fish breeding apparatus having a priming water profile according to one embodiment of the present invention.

FIGS. 5A-5C show the fish breeding apparatus of FIG. 4 having a spawning water profile according to one embodiment of the present invention.

FIGS. 6A-6C show a spawning platform according to one embodiment of the present invention. FIG. 6A shows a top view, with a cut-away portion (with the mesh removed in the lower portion) exposing the support elements. FIGS. 6B and 6C show cross sections A-A and B-B of FIG. 6A, respectively.

FIGS. 7A-7D show a fish breeding apparatus according to an alternative embodiment of the present invention. FIG. 7A shows the fish breeding apparatus having a priming water platform according to one embodiment of the invention. FIGS. 7B-7C show a fish breeding apparatus having a spawning water platform according to one embodiment of the invention. FIG. 7D shows a detail view of the U-shaped and L-shaped support elements on the support frame of a fish breeding apparatus according to the invention.

### DETAILED DESCRIPTION

The invention presented herein is not limited to the particular methodology, protocols, and reagents, etc., described herein and as such may vary. The terminology used herein is for the purpose of describing particular embodiments only, and is not intended to limit the scope of the present invention, which is defined solely by the claims.

As used herein and in the claims, the singular forms include the plural reference and vice versa unless the context clearly indicates otherwise. Other than in the operating examples, or where otherwise indicated, all numbers expressing quantities of ingredients or reaction conditions used herein should be understood as modified in all instances by the term “about.”

All patents and other publications identified are expressly incorporated herein by reference for the purpose of describing and disclosing, for example, the methodologies described in such publications that might be used in connection with the present invention.

These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Unless defined otherwise, all technical and scientific terms used herein have the same meaning as those commonly understood to one of ordinary skill in the art to which this invention pertains. Although any known methods, devices, and materials may be used in the practice or testing of the invention, the methods, devices, and materials in this regard are described herein.

The present invention pertains to methods, apparatuses, and kits for the production of fish embryos, and for illustration purpose, the invention will be described in the context of production of Danio rerio (zebrafish) embryos. Although zebrafish embryo production methods, apparatuses and kits are known within the art, the present invention provides for zebrafish embryo production that is high volume, efficient, and less time and labor intensive than other approaches. By maximizing the shallow water surface area topography that is in alignment with zebrafish spawning preferences (an undulating topography of shallow and deeper zones), the present invention allows for the rapid collection of tightly developmentally synchronized embryos and the completion of experiments in days to weeks instead of months.

Utilizing the methods, apparatuses and kits in accordance with biologically preferred zebrafish spawning traits, as described herein, is not known to the art. Those skilled in the art can readily adjust the methods, apparatuses and kits described herein, by adhering to environmental and behavioral spawning preferences of zebrafish in the wild, to accommodate wide ranging types of experimental model according to the criteria described herein.

### Natural History

Zebrafish are native to South Asia, and are distributed primarily throughout the lower reaches of many of the major river drainages of India, Bangladesh, and Nepal. This geographic region is characterized by its monsoonal climate, with pronounced rainy and dry seasons. Such seasonality in rainfall profoundly affects both the physicochemical conditions in zebrafish habitats, as well as resource availability. These factors also shape reproductive biology and behavior.

Data gathered from the relatively small number of field studies to date suggests that zebrafish are primarily a floodplain species, most commonly found in shallow, standing or slow moving bodies of water with submerged aquatic vegetation and a silt-covered substratum. Environmental conditions in these habitats are highly variable in both space and time. For example, pooled environmental data from zebrafish collection sites in India in the summer rainy season and Bangladesh in the winter dry season show that pH ranges from 5.9-8.5, conductivity from 10-2000 uS, and temperature from 16-38° C. These differences, which reflect changes in seasonality and geography, provide strong evidence that zebrafish are adapted to wide swings in environmental conditions. Results of laboratory experiments demonstrating their tolerance to both thermal and ionic fluctuations support this hypothesis.

Zebrafish feed chiefly on a wide variety of zooplankton and insects (both aquatic and terrestrial), and to a lesser extent, algae, detritus, and various other organic materials. Gut content analyses of wild collected animals indicate that they feed primarily in the water column, but will take items off the surface and the benthos.

Zebrafish are a shoaling species, most often occurring in small schools of 5-20 individuals, although shoals of much larger numbers have been observed. Reproduction takes place primarily during the monsoons, a period of resource abundance.{Talwar, 1991, Inland fishes of India and adjacent countries} Fish spawn in small groups during the early morning, along the margins of flooded water bodies, often in shallow, still, and heavily vegetated areas. There has also been at least one report of fish spawning during periods of heavy rain later on in the day. Females scatter clutches of embryos over the substratum, and there is no parental care. The embryos, which are demersal and non-adhesive, develop and hatch with 48-72 hours at 28.5° C. After hatching, larvae adhere to available submerged surfaces by means of specialized cells on the head. Within 24-48 hours post hatch, they inflate their gas bladders and begin actively feeding on small zooplankton. Larval fish remain in these nursery areas as they develop, and move into deeper, open water as they mature and floodwaters recede.

### Proper Zebrafish Maintenance for Optimal Embryo Production

Reproductive Cycle and Controlling Factors

Zebrafish typically attain sexual maturity within three to six months post-fertilization in laboratory settings, although this may vary considerably with environmental conditions, most importantly rearing densities, temperature, and food availability. Consequently, it may be more appropriate to relate reproductive maturity to size rather than age. Data from a number of studies indicates that a standard length of approximately 23 mm corresponds with attainment of reproductive maturity in this species.

Under favorable conditions, zebrafish spawn continuously upon attainment of sexual maturation. Females are capable of spawning on a daily basis. Eaton and Farley found that females would spawn once every 1.9 days if continuously housed with a male, and Spence and Smith reported that females were capable of producing clutches every day over a period of at least 12 days, though variance in embryo production was substantial. This interval is likely to be greater when the environmental (water chemistry, nutrition, behaviorial setting, etc.) is suboptimal or if the fish are used for production frequently.

Olfactor cues play a determining role in zebrafish reproduction and spawning behavior. The release of steroid glucuronides into the water by males induces ovulation in females. Gerlach reported that females exposed to male pheromones showed significant increases in spawning frequencies, clutch size, and embryo viability when compared with females held in isolation. {Gerlach, 2006, Pheromonal regulation of reproductive success in female zebrafish: female suppression and male enhancement} Upon ovulation, females release pheromones that in turn prompt male mating behavior that immediately precedes and elicits oviposition and spawning. Pheromonal release in some cases also appears to suppress reproduction, as holding water from “dominant” female zebrafish has been shown to inhibit spawning of subordinate females.

Reproduction in zebrafish is also influenced by photoperiod. Ovulation most typically occurs just prior to dawn and spawning commences within the first few hours of daylight. However, spawning is not strictly limited to this time period. Zebrafish will breed in the laboratory throughout the day, particularly during the evenings, although spawning is most reliable and intense in the early morning (personal observation). In the wild, zebrafish have also been observed spawning during the afternoon following the onset of heavy rain.

Nutrition and Feeding

Nutrition and feeding are among the most important determinants of reproductive success—or failure—in zebrafish facilities. Therefore, to ensure efficient, and scientifically sound management of breeding stocks, it is essential that managers and technicians possess a thorough understanding of fish nutrition and the different types of feeds available, as well as the techniques to deliver them.

While the specific nutritional requirements of zebrafish are yet to be determined, it is possible to apply scientific principles of fish nutrition, along with what zebrafish specific data does exist in the design of diets and feeding regimens that will support high levels of production. At the most general level, stocks should be fed balanced diets with adequate levels of essential nutrients: proteins, lipids, carbohydrates, vitamins and mineral. Deficiencies in essential nutrients will result in reduced production, low growth, and decreased immune function, among other problems.

At minimum, it is also crucial to ensure that diets used for breeding populations of zebrafish contain adequate levels of specific nutrients known to support reproductive function in fishes. Most notably, these include the highly unsaturated fatty acids (HUFAs) eicosapentaenic acid (20:5n-3; EPA), docsahexaenoic acid (22:6n-3; DHA), and arachidonic acid (20:4n-6; AA), all of which are of pivotal importance for the production of high quality gametes and offspring, and have been specifically shown to enhance reproduction in zebrafish. Certain vitamins, including retinoids and ascorbic acid in particular, are also known to be extremely important for long-term reproductive quality and health, and should be considered in diet selection.

The type of feed is also of critical importance. Zebrafish may be fed live prey items, processed diets, or some mixture of the two. Since the specific nutritional requirements of zebrafish have yet to be determined, and may be fundamentally different from even closely related species, it may be unwise to feed an exclusively processed diet, especially since systematic studies of adult zebrafish performance on these diets are not available. Live prey items such as Artemia typically possess relatively balanced nutritional profiles and therefore are most likely to meet much of the requirements of zebrafish. Processed diets may be included to the diet as a supplement to Artemia, as they can be used to deliver specific nutrients that may not be present in sufficient levels in Artemia or other live prey items. For example, Artemia are deficient in DHA and in stabilized vitamin C. One way to address these inadequacies is to incorporate a prepared feed containing known levels of these nutrients into the diet to help ensure that these dietary requirements are adequately met and reproductive function is supported.

Finally, it is essential that feeds be stored and administered properly. This is particularly critical for processed feeds. The typical maximal shelf life of a processed feed does not exceed three months, when maintained in cool, dry conditions. Oxidation of feed components, particularly fatty acids, increases with temperature. Thus, feeds should be kept in airtight containers, refrigerated, and discarded after 3 months to ensure that fish stocks derive maximal nutritional benefit from their application. In terms of delivery, processed feeds should be fed dry to minimize leeching of water-soluble amino acids and vitamins upon administration.

Genetic Management

With respect to genetic management, small, closed populations of laboratory strains of animals such as zebrafish are subject to a continuous loss of genetic diversity stemming from founder effects, genetic drift, and population bottlenecking. This loss of genetic diversity can cause a number of problems relative to reproductive potential of zebrafish breeding stocks. Continued breeding between close relatives will lead to accumulation deletrious alleles in breeding populations. These alleles may directly affect a number of factors related to reproduction, including reduced quantity and quality of embryos. Reduced genetic diversity may also manifest itself in reduced spawning rates, as zebrafish show preference to associate with non-relatives over siblings or closely related individuals. This mode of kin recognition, which is thought to help avoid inbreeding in natural populations, may result in decreased spawning rates when fish in a breeding population are closely related.

These and other problems related to the loss of genetic diversity may be alleviated to a certain extent by careful genetic breeding programs that 1) maximize effective population size, and 2) minimize breeding between siblings or close relatives. Genetic diversity may also be maintained or enhanced by periodically importing fish from outside populations and breeding them programmatically with existing stocks.

Behavioral Management

Behavioral management is also an important consideration. Zebrafish reproductive behavior is complex and undoubtedly exerts myriad effects on reproductive potential of breeding stocks. The most notable instance of this type of dynamic involves social interactions between fish in holding tanks. Dominant females have been shown to suppress embryo production in subordinate females via release of pheromones. Further, aggression arising during formation of dominance hierarchies and territory establishment by both males and females is a source of both acute and chronic stress that may also decrease reproductive output.

Employing various strategies of behavioral management may help to minimize the potentially negative effects of such interactions on the reproductive capacity of breeding stocks. For example, the establishment of dominance hierarchies detrimental to breeding may be prevented to some extent by regularly mixing fish from different tanks and periodically flushing tanks and systems with fresh water to reduce concentrations of repressive pheromones circulating in the water. Additionally, maintaining fish at intermediate densities in holding tanks may also reduce the frequency and intensity of antagonistic interactions, which are highest when densities are low and territories are easiest to defend.

Water Quality

With respect to water quality, zebrafish tolerate a wide range of environmental conditions in captivity. This flexibility is a reflection of their distribution in the wild, as they are found across a range of habitat types that vary considerably in their physico-chemical properties as a result of local geology and pronounced seasonal fluctuations in rainfall patterns. However, it should be recognized that there is an energetic cost to fish in operating outside their optimum range of environmental parameters. Animals maintained under sub-optimal conditions must devote an increasing proportion of energy towards maintaining homeostasis, rather than on growth, reproduction, and immune function. Consequently, one major consequence of fish being held under sub-optimal conditions is a decrease in the number and quality of offspring. Thus, it is vital to manage water chemistry as close to optimal as possible to ensure that fish allocate resources to reproductive function.

Stability within a given range of each parameter is also crucial, and may be more important than maintaining at optimum, especially for a generalist species like zebrafish. Adapting to constantly fluctuating environmental conditions is energy-intensive, and can be a source of chronic stress that manifests itself in decreases in quality of offspring and quantity.

While managing water quality for stability within optimum ranges is straightforward conceptually, it is a bit more challenging to achieve in practice, primarily because optimum environmental conditions for zebrafish have for the most part have yet to be demonstrated experimentally. Until such data are available, the most sound practice is to base management on the best available scientific information. Observational data from years of experimental use along with concepts gleaned from biological studies of zebrafish allow for a reasonable place to start, however. A detailed treatment of each eof these factors relative to the management of zebrafish is given in the review by Lawrence, which is incorporated fully herein by reference (Harper, C., and Lawrence, C. (2010) The Laboratory Zebrafish. CRC Press, Boca Raton, Fla.). One of ordinary skill in the art will recognize that for optimal spawning, excess metabolites that have built up overnight should be removed, which can be accomplished manually. Alternatively, a flow system can be employed to allow for the right balance of consistently, or on an interval basis, both the drainage and replenishing of water supplies. Those of ordinary skill in the art can readily adjust the volume-in to volume-out ratio without undue experimentation.

Reproductive Behavior

Zebrafish display ritualized courtship behaviors prior to and during spawning. During courtship, males swim in tight circles or hover, with fins raised, above a spawning site in clear view of nearby females. If females do not approach, males will chase them to the site, snout to flank. When spawning, a male swims parallel to a female and wraps his body around hers, triggering oviposition and releasing sperm simultaneously. This ritualized mating behavior and the fact that males are known to establish and defend territories indicates that females are selective. This is supported by the fact that females will produce large clutches and spawn more frequently when paired with certain males.

Females may exert choice on the basis of several combined factors. The quality of a spawning site is clearly important, as both male and female zebrafish show a strong preference for oviposition site, selecting and preferentially spawning over gravel versus silt in both laboratory and field-based experiments. If given the choice, fish will also spawn preferentially in vegetated versus non-vegetated sites and in shallow versus deep water.

Male defense of territories may be one cue that females use to select males. Spence and Smith found that territorial males had a marginally higher reproductive success than non-territorial males at low densities, and that male dominance rank did not correlate with female embryo production. This fact, coupled with female preferences for substrate, depth, and structure for spawning, suggests that male defense of desirable spawning locations over which females are choosy may be the basis to the zebrafish mating system.

Females appear to select males based on their genotype. Many fishes, including zebrafish, use olfactory cues to differentiate between kin and non-kin, and this mechanism may be utilized during breeding to avoid interbreeding. Zebrafish also appear to use olfactory cues to make social and reproductive decisions. Using odor plume tests, Gerlach and Lysiak showed that adult female zebrafish chose the odors of non-related, unfamiliar (reared and maintained separately) males over those of unfamiliar brothers for mating. The underlying genetic basis of this preference is unknown, but may be the major histocompatability complex (MHC) genes that are important in kin recognition in other fish species.

### DESCRIPTION OF THE METHOD

By particularly exploiting the natural tendency of zebrafish to spawn in shallow water along a depth gradient of shallow and deeper zones, there is provided, according to the invention, a method for mass producing developmentally synchronized zebrafish embryos comprising the steps of,
(i) providing both sexes of zebrafish in a priming water profile, which is characterized by having a deeper water depth relative to the spawning water profile; and
(ii) providing both sexes of zebrafish in a spawning water profile, which is characterized by having a shallower depth relative to the priming water profile; and
(iii) collecting the embryos.

Priming Water Profile

The priming water profile can also be deemed a deep water profile. However, there is no specific depth or volume that is required to optimize the embryo production according to the invention described herein. Rather, it is sufficient that the priming water profile be deep enough to allow for the creation of a spawning water profile, which is characterized by a shallower depth than the priming water profile and an undulating topography.

There is so no singular determining factor for creating the priming water profile. One of ordinary skill in the art can determine the particular depth and volume of the priming water profile without an undue amount of experimentation by paying careful attention to the criteria described herein. Taking into consideration the size and number of the fish to be bred in the tank of the spawning system, the priming water profile can be determined such that the fish can swim freely and female fish can relatively easily swim away from males attempting to spawn with them. For example, for Zebrafish, the priming water profile can be about 2″ or more of water in depth. For younger Zebrafish (and smaller fish in general) priming water profile depths can be as shallow as 1″ in depth.

Although the methods, apparatuses and kits described herein allow for both sexes of fish to be mixed upon introduction into a tank or vessel, the fish will be best primed for spawning when separated within the priming water profile until the initiation of spawning. In one embodiment, separation is achieved by a physical barrier that allows each sex of zebrafish to see or sense the other sex, and further allows for pheromone exchange between sexes. Thus, the zebrafish can sense the presence of the opposite sex in the tank using visual, auditory or vibrational, or olfactory senses. Spawning is initiated by allowing the sexes of fish to mix and isolating the fish in a spawning water profile. In some embodiments, the separator platform is see-through. In some embodiments, the separator platform is comprised of a perforated material. In some embodiments, the separator platform is comprised of mesh.

Spawning Water Profile

Similar to the priming water profile, there is no singular determining factor for the spawning water profile, except that it is to be characterized by having an overall shallower depth relative to the priming water profile. In a preferred embodiment, the spawning water profile has an undulating topography. Those of ordinary skill in the art will recognize that variations in undulation height are readily adjustable so long as an undulating gradient of shallow and deeper zones is maintained. Taking into consideration the size and number of fish to be bred, the spawning water profile can be determined such that the fish cannot swim freely and female fish can not easily swim away from males attempting to spawn with them. For example, for Zebrafish, the spawning water profile can be about 2″ or less of water in depth below the water-air interface. For younger Zebrafish (and smaller fish in general) spawning water profile depths can be in the 0.5″ to 2″ range. In one embodiment, the low points of undulation can be about 1″ to 3″ below the water-air interface, exposing the “high parts” of the mesh to air.

Embryo Collection

Embryos can be collected from the embryo deposition site in a variety of ways. In some embodiments, a zebrafish impermeable, embryo permeable physical barrier is located between the zebrafish and the embryo deposition site. In some embodiments, an additional, water permeable, embryo impermeable physical barrier comprises the embryo deposition site. In some embodiments, water pressure, as determined by one of ordinary skill in the art, is applied to the sides of the chamber in which the method is performed to keep the embryos from sticking to the sides of the vessel prior to embryo deposition. In some embodiments, the water and fish can emptied from the tank, leaving the embryos to be collected. In other embodiments, the tank can include a funnel shaped collection area leading to a valve that allows the embryos to be collected by opening the valve.

### Description of the Apparatus & Kit

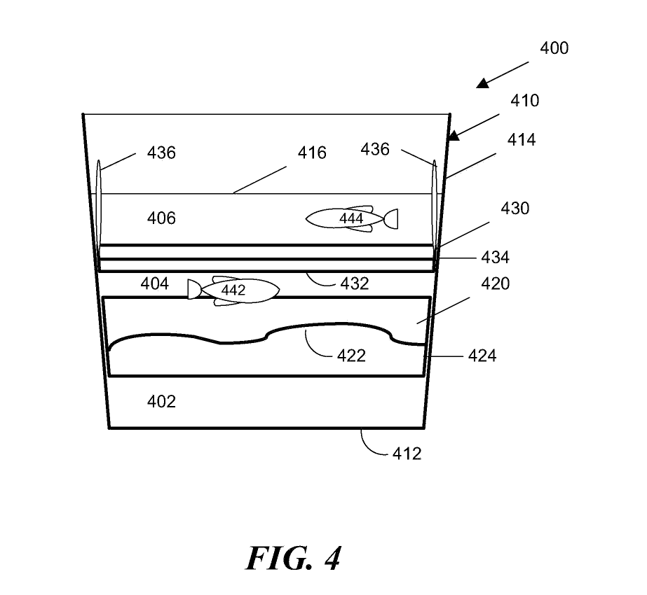

The following detailed description of the apparatus refers to the accompanying drawing FIGS. 4-7D. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

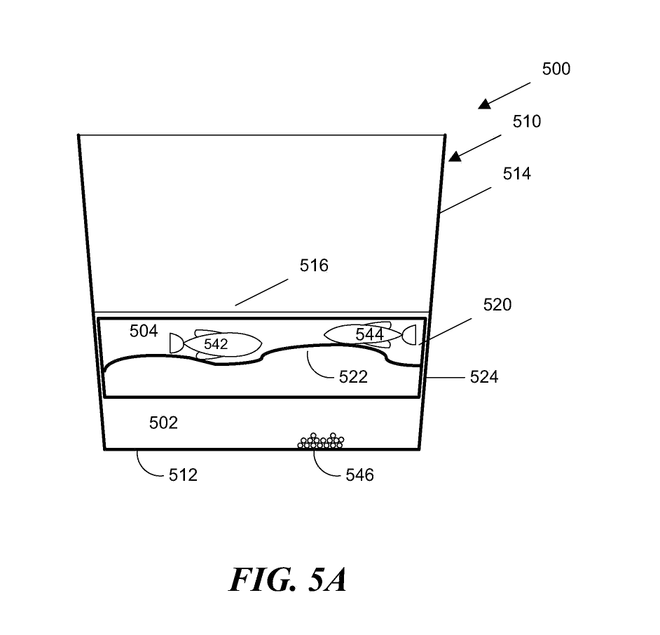

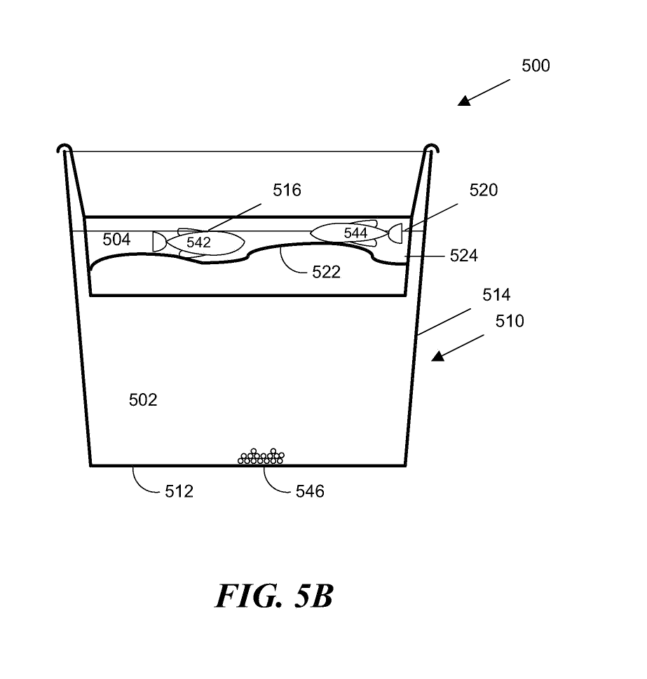

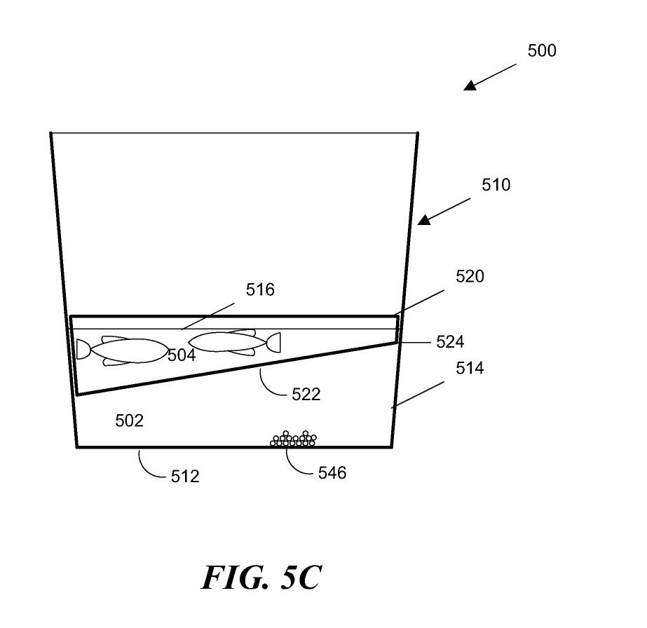

FIGS. 4 and 5A-5C show one embodiment of a fish breeding device according the present invention. The fish breeding device 400 can include a breeding tank 410, a spawning platform 420 and a separator 430. The breeding tank 410 can include a bottom surface 412 and side walls that enable the tank 410 to hold a volume of water at a predetermined water level 416, the water-air interface. The spawning platform 420 can be placed in the tank 410 and can be adapted to sit just above the bottom surface 412 of the tank 410. The spawning platform can be positioned to divide the tank 410 into two chambers, the lower chamber 402 below the spawning platform 420 and a first upper chamber 404 above the spawning platform 420. The separator 430 can be placed in the tank 410 above the spawning platform 420 and can be used to form a second upper chamber 406 above the spawning platform. In operation, the separator 430 serves to separate the male fish in the second upper chamber 406 from the female fish in the first upper chamber 404 during the isolating or priming phase of the method according to the invention. At the end of the priming phase, the separator 430 can be removed to allow the fish to mingle in the spawning phase of the method according to the invention.

The spawning platform 420 can be designed to fit inside the breeding tank 410 and have the same general shape as the inside of the breeding tank 410. The spawning platform 420 can include a frame 424 that supports a porous element 422 that allows embryos (or eggs) to pass through the pores and settle at the bottom of the tank 410 and at the same time prevents the spawning fish from eating or otherwise harming the embryos. In one embodiment of the invention, the porous element 422 can be a mesh material that includes a maximum pore size to allow embryos to pass through without allowing the fish to pass through as well. The porous element 422 can be a solid material with holes of sufficient size to embryos to pass through without allowing the fish to pass through as well. The holes can be tapered hole or a countersink into the bottom surface of the breeding platform 420. In some embodiments of the invention, the porous element 422 can include an undulating profile.

The separator 430 can include a frame 434 that supports a porous element 432. The frame 434 can be designed to fit inside the breeding tank 410 and have the same general shape of the inside of the breeding tank 410 in order to separate the male fish 444 from the female fish 442 in the upper chambers. The pores or holes of the porous element 432 of the separator 430 can be selected to allow the male fish 444 and the female fish 442 to sense the presence of the other through sight, hearing and smell without passing through the separator 430 as part of the priming phase. The porous element 432 can be a solid material with holes or a mesh material that separates the male fish 444 from the female 442 and prevents them from spawning. The separator 430 can include one or more handles 436 that enable the separator to be removed to allow the fish to mingle and spawn.

As shown in FIG. 4, the water level 416 is sufficiently high to allow the fish to swim freely such that even after the separator 430 is removed the fish are able to swim freely, providing a priming water profile. In accordance with one embodiment of the present invention, the priming water profile provides at least 2″ of water depth from the highest point on the porous element 422 to the water-air interface. In some embodiments, the priming water profile provides at least 3″ of water depth and this depth can be adjusted to accommodate the age, size and spawning preferences of the fish. In other embodiments of the invention, the priming water profile can provide less water depth where the fish are smaller and more water depth where the fish are larger. In some embodiments of the invention, the depth of the priming water profile will be sufficient to enable the male and female fish to mingle and to enable the female fish to get away from male fish attempting to spawn with them.

After a predetermined period of time, the separator 430 can be removed to allow the male and female fish to mingle. As shown in FIG. 5A, the spawning platform 520 can be moved to a different breeding tank 510, where the water level 516 is lower, in accordance with a spawning water profile. Alternatively, the water level 516 can be lowered by removing water from the breeding tank 510, such as by pumping (using for example a suction pump) or draining the water from the tank 510. In accordance with one embodiment of the invention, the spawning water profile provide a maximum water depth of 2″ from the lowest point on the porous element 522 of the water-air interface. In other embodiments of the invention, the spawning water profile can provide a smaller maximum depth where the fish are smaller and a greater maximum depth where the fish are larger. In some embodiments of the invention, the depth of the spawning water profile will be sufficiently shallow to cause the male and female fish to mingle more closely than the priming water profile and to limit the female fish's ability to get away from male fish attempting to spawn with them. As a result of spawning, the embryos 546 fall through the pores or openings of the porous element 522 of the spawning platform 520 and are deposited on the bottom 512 of the breeding tank 510 to be collected.

FIG. 5B shows an alternate embodiment of the present invention. In this embodiment, instead of moving the spawning platform 520 or lowering the water level as shown in FIG. 5A, the spawning platform 520 can include handles 526 that allow the spawning platform 520 to be raised and held in place, such as by hooks 526A, 526B, or other fastening or supporting elements that can support the spawning platform 520 in a raised position. In some embodiments, the handles 526 and/or the hooks 526A, 526B can be adjustable to enable the height of the spawning water platform 520 and depth of the water associated with the spawning water profile to be adjusted.

FIG. 5C shows an alternate embodiment of the present invention. In this embodiment, the porous element 522 of the spawning platform 520 is angled or slanted with respect to horizontal. In this embodiment, when the spawning platform 520 or the water level is positioned according to spawning water profile, the depth of the water above the porous element 522 can vary according to location in the breeding tank 510. In one embodiment of the invention, the water depth of the spawning water profile can range from 0″ to 3″. In other embodiments of the invention, the spawning water profile can provide a smaller maximum depth where the fish are smaller and a greater maximum depth where the fish are larger. In some embodiments of the invention, the depth of the spawning water profile will be sufficiently shallow to cause the male and female fish to mingle more closely than the priming water profile and to limit the female fish's ability to get away from male fish attempting to spawn with them. As a result of spawning, the embryos 546 fall through the pores or openings of the porous element 522 of the spawning platform 520 and are deposited on the bottom 512 of the breeding tank 510 to be collected.

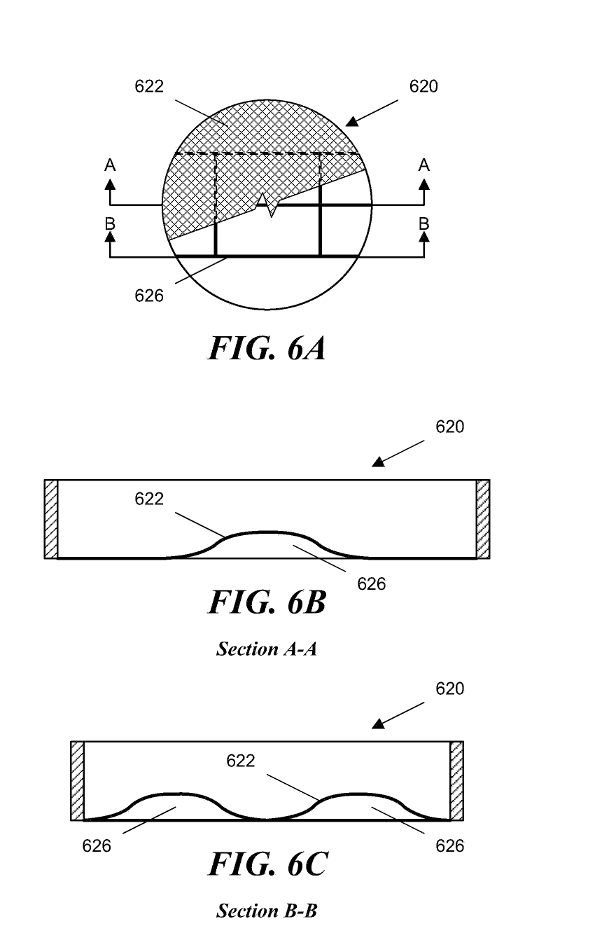

In some embodiments of the invention, the porous element 422 or 522 can uneven, for example, such as an undulating surface providing deeper and shallower areas depending on the location with the breeding tank 510. FIGS. 6A-6C shown an undulating surface in accordance with one embodiment of the invention. FIG. 6A shows a top view of the spawning platform 620 according to one embodiment of the invention. In this embodiment, the porous element 622 is formed from a mesh material having pores or openings that are of sufficient size to allow fish embryos to pass through, without permitting the fish to pass through. As shown in FIG. 6A, the spawning platform 620 can include one or more support members 626 extending along the bottom of the spawning platform 620 to support the mesh material 628. As shown in FIGS. 6B and 6C, the support members 626 can be raised in some areas 626A and providing varying water depths in the spawning water profile. FIG. 6B shows section A-A through the center of the spawning platform 620 and FIG. 6C shows section B-B through an off-center location of the spawning platform 620. In this example, several raised or undulating areas are provided. FIGS. 4, 5A and 5B show spawning platforms 420 and 520 having alternate undulating configurations.

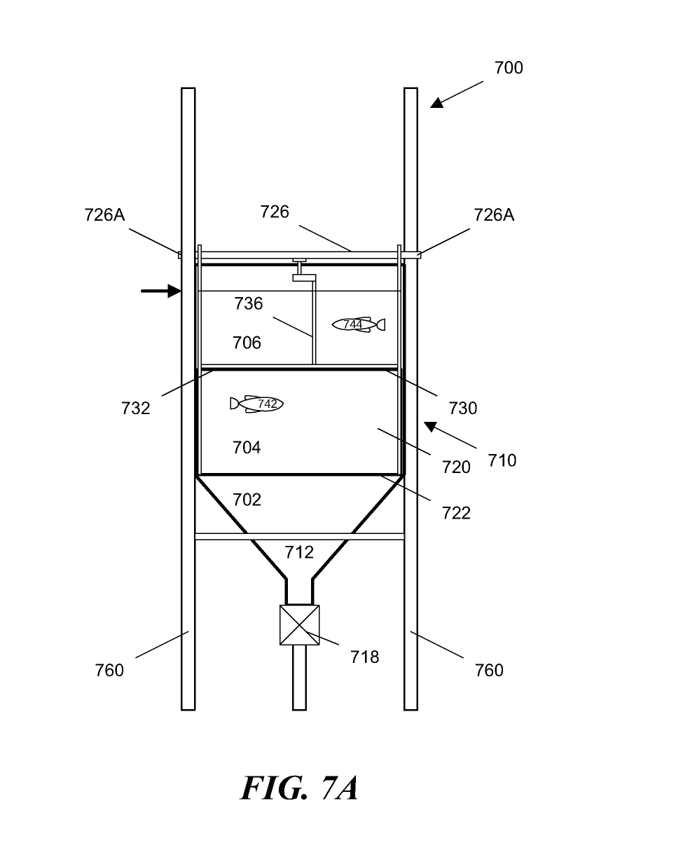

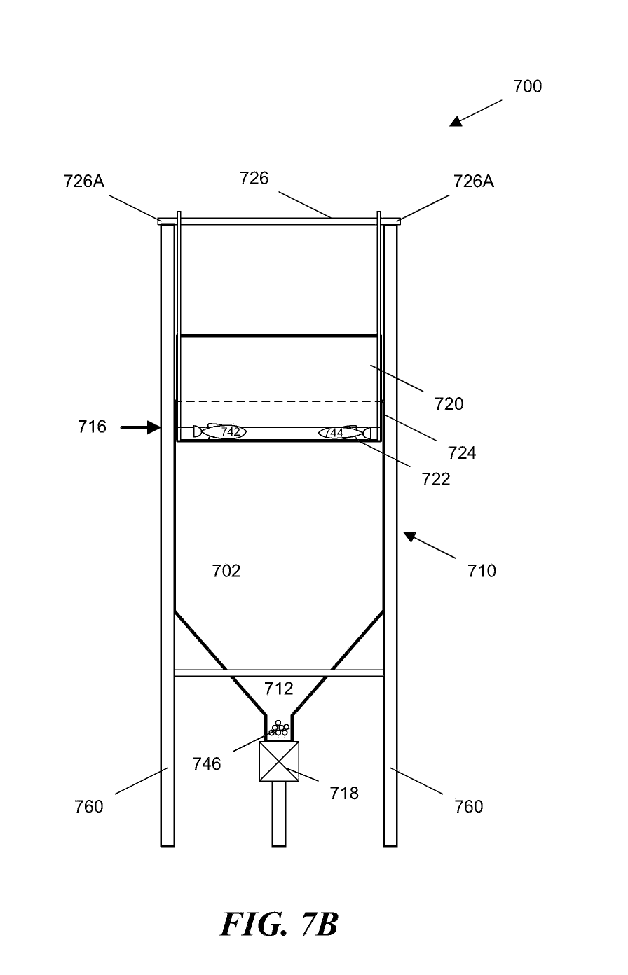

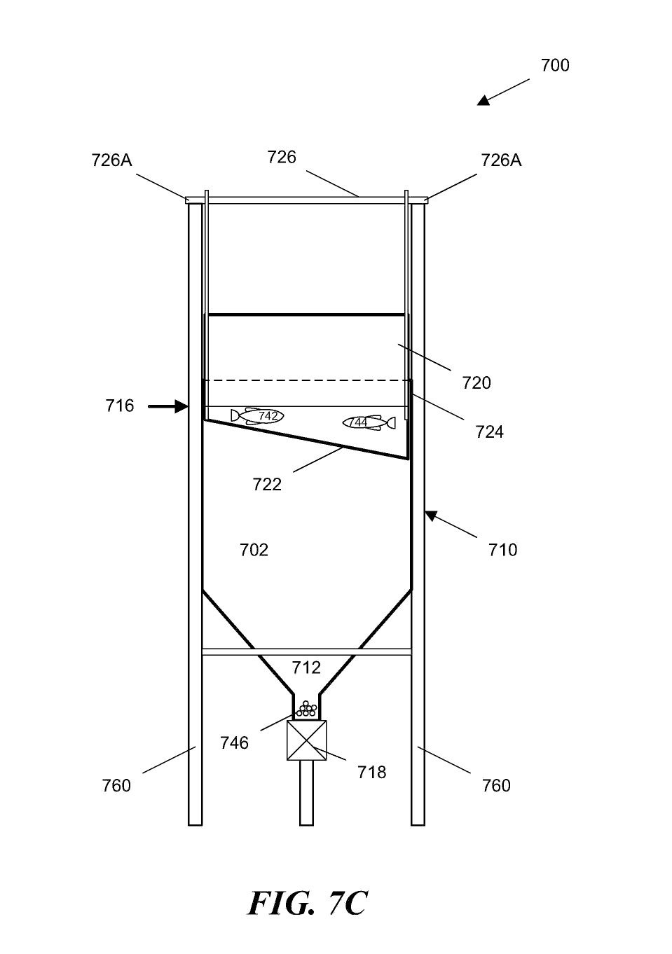

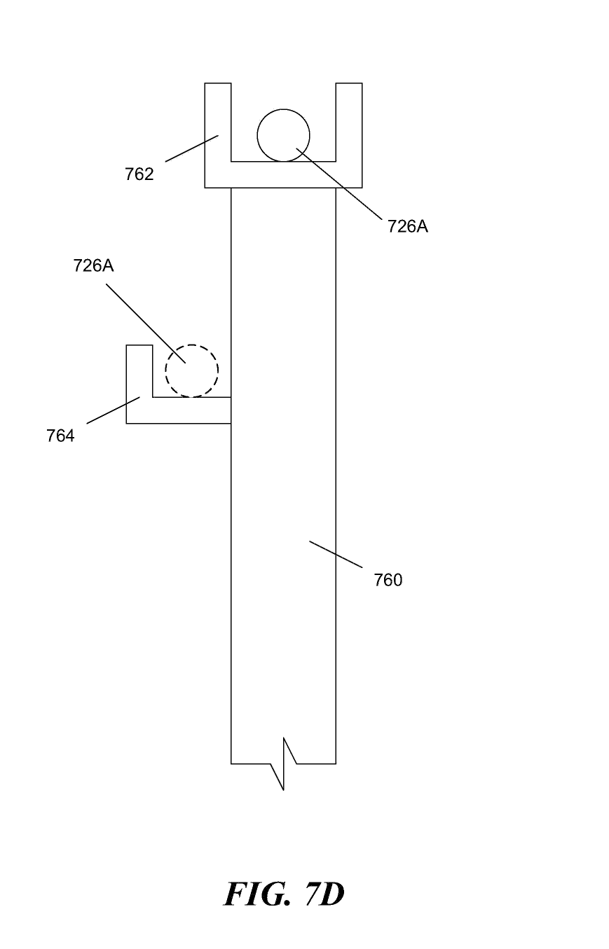

FIGS. 7A-7C show an alternative embodiment of a fish breeding device according the present invention. The fish breeding device 700 can include a breeding tank 710, a spawning platform 720, a separator 730 and a support frame 760. The breeding tank 710 can include a bottom collection area 712 and side walls that enable the tank 710 to hold a volume of water at a predetermined water level 716, the water-air interface. The spawning platform 720 can be placed in the tank 710 and can be adapted to sit just above the bottom collection area 712 of the tank 710. The spawning platform 720 can be positioned to divide the tank 710 into two chambers, the lower chamber 702 below the spawning platform 720 and a first upper chamber 704 above the spawning platform 720. The separator 730 can be placed in the tank 710 above the spawning platform 720 and can be used to form a second upper chamber 706 above the spawning platform. In operation, the separator 730 serves to separate the male fish in the second upper chamber 706 from the female fish in the first upper chamber 704 during the isolating or priming phase of the method according to the invention. At the end of the priming phase, the separator 730 can be removed to allow the fish to mingle in the spawning phase of the method according to the invention.

The spawning platform 720 can be designed to fit inside the breeding tank 710 and have the same general shape as the inside of the breeding tank 710. The spawning platform 720 can include a frame 724 that supports a porous element 722 that allows embryos (or eggs) to pass through the pores and settle at the bottom collection area 712 of the tank 710 and at the same time prevents the spawning fish from eating or otherwise harming the embryos. In one embodiment of the invention, the porous element 722 can be a mesh material that includes a maximum pore size to allow embryos to pass through without allowing the fish to pass through as well. The porous element 722 can be a solid material with holes of sufficient size to embryos to pass through without allowing the fish to pass through as well. The holes can be tapered hole or a countersink into the bottom surface of the breeding platform 720. In some embodiments of the invention, the porous element 722 can include an undulating profile, such as shown in FIGS. 6A-6C. In other embodiments, the porous element 722 can be a flat horizontal surface. In still other embodiments, the porous element 722 can be an angled or slanted, flat horizontal surface as shown in FIG. 7C. The angle of the slant can range from 1 degree with respect to horizontal to 45 degrees with respect to horizontal. Alternatively, the slant can be selected to provide a range for the depth of the water associated with the spawning water profile. For example, in some embodiments, the depth can range from less than 0.5″ deep to 2″ deep. In other embodiments the depth can range from 0″ deep to 4.25″ deep or more over the extent of the slanted surface. In still other embodiments, in addition to being slanted, the porous element 722 can be undulating as shown in FIGS. 6A-6C.

The spawning platform 720 can include a handle 726 that allows the spawning platform to be raised to provide a spawning water profile or lowered to provide a priming water profile. The handle 726 can include projections 726A which extend beyond the outer dimension of the spawning water platform 720 and can be used to support the spawning platform 720 in one or more positions inside the breeding tank 710. As shown in FIG. 7A, in the lower position, associated with the priming water profile, the projections 726A can rest on the top edge of the breeding tank 710. As shown in FIG. 7B, in one upper position, associated with the spawning water profile, the projection 726A can rest on the top of the support frame 760. The support frame 760 can include U-shaped brackets 762 to hold the spawning platform 720 in the upper position and reduce the possibility of the spawning platform falling off the support frame 760 as shown in FIG. 7D. Additional, brackets, such as L-shaped or similar brackets can be provided that support the spawning platform 720 in other upper positions as shown in FIG. 7D.

The separator 730 can include a frame 734 that supports a porous element 732. The frame 734 can be designed to fit inside the breeding tank 710 and have the same general shape of the inside of the breeding tank 710 in order to separate the male fish 744 from the female fish 742 in the upper chambers. The pores or holes of the porous element 732 of the separator 730 can be selected to allow the male fish 744 and the female fish 742 to sense the presence of the other through sight, hearing and smell without allowing the fish to pass through the separator 730 as part of the priming phase. The porous element 732 can be a solid material with holes or a mesh material that separates the male fish 744 from the female 742 and prevents them from spawning. The separator 730 can include one or more handles 736 that enable the separator 730 to be removed to allow the fish to mingle and spawn.

As shown in FIG. 7A, the water level 716 is sufficiently high to allow the fish to swim freely such that even after the separator 730 is removed the fish are able to swim freely, providing a priming water profile. In accordance with one embodiment of the present invention, the priming water profile provides at least 2″ of water depth from the highest point on the porous element 722 to the water-air interface. In some embodiments, the priming water profile provides at least 3″ of water depth and this depth can be adjusted to accommodate the age, size and spawning preferences of the fish. In other embodiments of the invention, the priming water profile can provide less water depth where the fish are smaller and more water depth where the fish are larger. In some embodiments of the invention, the depth of the priming water profile will be sufficient to enable the male and female fish to mingle and to enable the female fish to get away from male fish attempting to spawn with them.

After a predetermined period of time, the separator 730 can be removed to allow the male and female fish to mingle. As shown in FIG. 7B, the spawning platform 720 can be raised allowing the projections 726A to rest on the top of the support frame 760, providing a lower water level 716 relative to the porous element 722, in accordance with a spawning water profile. Alternatively, the water level can be lowered by removing water from the breeding tank 710, such as by pumping (using for example a suction pump, not shown) or draining the water from the tank 710 through valve 718. In accordance with one embodiment of the invention, the spawning water profile provides a maximum water depth of 2″ from the lowest point on the porous element 722 of the water-air interface. In other embodiments of the invention, the spawning water profile can provide a smaller maximum depth where the fish are smaller and a greater maximum depth where the fish are larger. In some embodiments of the invention, the depth of the spawning water profile will be sufficiently shallow to cause the male and female fish to mingle more closely than the priming water profile and to limit the female fish's ability to get away from male fish attempting to spawn with them. As a result of spawning, the embryos 746 fall through the pores or openings of the porous element 722 of the spawning platform 720 and are deposited on the bottom collection area 712 of the breeding tank 710 to be collected. The embryos can be collected by opening the valve 718.

### EXAMPLES

### Example 1

### Assessing an Embodiment of the Kit and Method

### General Materials and Methods for Example 1.

In accordance with one embodiment, the spawning platform can be constructed by cutting a section from a 5-gallon bucket. The first cut was made 1 inch above the bottom of the bucket to remove the bucket floor. A second cut was made approximately 4 inches above the first cut leaving a plastic band (4″ high×˜12″ diameter). A ⅛″ plastic mesh was then glued to the inside bottom of the plastic band with a slightly undulating topography, see FIGS. 4 and 5A-5C.

In accordance with one embodiment of the invention, the male/female separator can be constructed by cutting another section of a 5-gallon bucket to make an additional plastic band (2″ high×˜12″ diameter). A ⅛″ mesh was glued flush to the top and bottom of the band creating a double-layered separator. A handle can be made by looping two zip-ties at opposite ends to the plastic band or using wires as shown in FIG. 5A.

The breeding tank can be an uncut 5-gallon bucket as shown in FIGS. 4 and 5A-5C. The breeding system can be setup as follows: At least 4-6 hours before embryos were desired, the 5-gallon bucket can be filled with water and the spawning platform can be pushed down towards the bottom of the bucket, maximizing volume and creating a priming water profile. Female Zebrafish can be added and a male/female separator can be pushed down inside the vessel, above the females. Males can then be added to the vessel and were effectively physically separated from the females below.

When the embryos were desired, the male/female separator can be tilted and removed from within the bucket allowing male fish to mix with the females. The spawning platform, along with the fish, can then be lifted out of the bucket and transferred to a second bucket, which is filled with less fresh water. The spawning platform can be placed inside the second bucket so that the bottom of the spawning platform was just below the water-air interface, exposing the “high parts” of the mesh to air. In this embodiment of the invention, the mesh of spawning platform was not tightly arranged and glued to the plastic band, it was loosely attached so that the depth of the water between the mesh and the water-air interface ranged from 1-3″ resulting in a spawning water profile. The resultant physical landscape thus promoted fish spawning behavior and oviposition. Fish can be kept in the spawning water profile for as long as eggs were desired or they stopped breeding.

Optionally, fish can then be transferred to another bucket (or the first bucket) to facilitate production and collection of embryos according to staged timepoints. The Timepoints can be stretched out over a number of hours by alternatively transferring fish from buckets with a priming water profile (no breeding) to buckets with a spawning water profile (breeding).

### Particular Materials and Methods for Experiment 1

Different populations of Tuebingen (Tu), AB, and Casper with various dates of birth were used per spawning event. Each setup consisted of a 1:3 male to female ratio with a total forty fish used per event. Twelve separate events with three embryo collections were performed. The first collection was performed in the morning on the day after setup (19 hours post setup) and two additional collections after two respective sixty minute spawning intervals was performed.

### Results for Experiment 1.

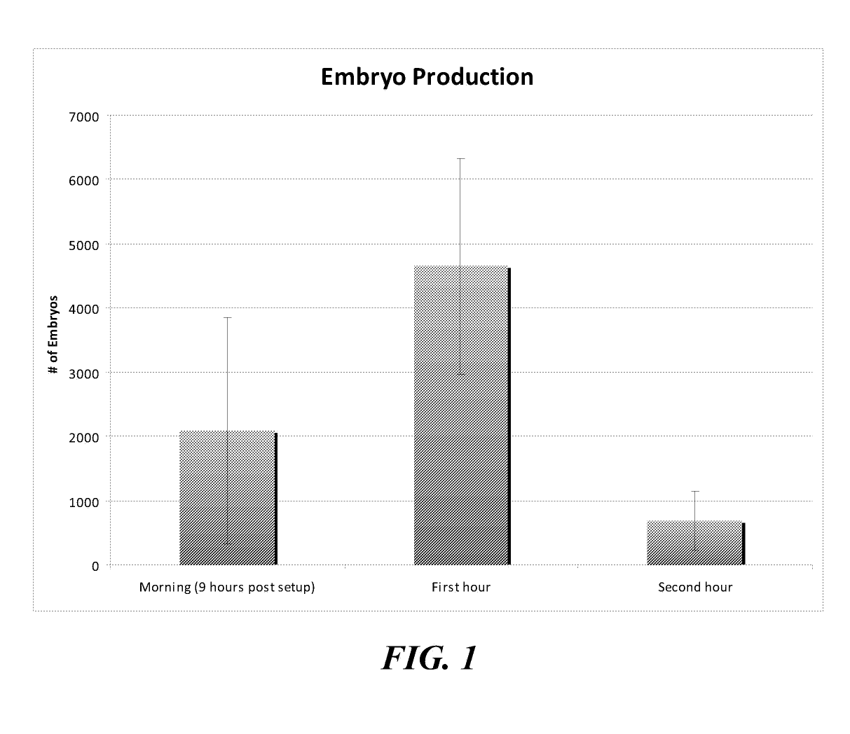

FIG. 1 shows the results of Example 1. Mean embryo collection nine hours post setup was 2092±1759. In the first hour within the spawning water profile, mean embryo collection was 4650±1690. Embryo collection the following hour (collection after second hour) consistently declined to a mean of 688±463.

### Example 2

### Assessing an Embodiment of the Kit and Method for the First Ten Minutes within the Spawning Water Profile

### Materials and Methods for Example 2.

The General Materials and Methods for Example 1 were utilized. Further, embryos were collected from a spawning group after a 10-minute interval, for six separate spawning events (10 males/30 females per event).

### Results for Example 2.

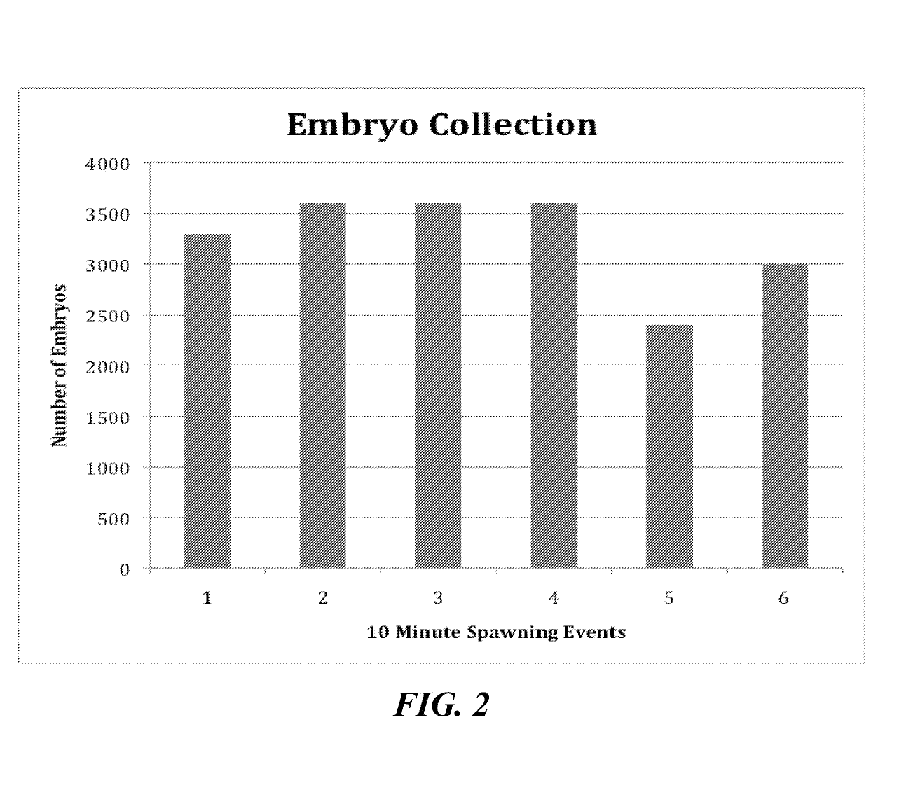

Mean yield was 3250±480 embryos, with a maximum clutch size of 3600 embryos. Collection after the initial 10 minutes declined as was seen in Experiment 1, but results were not recorded. The results for Example 2 are illustrated in FIG. 2.

### Example 3

### Zebrafish Exhibit Embryo Production in the Priming Water Profile without a Separator, but Still Spawn when Introduced into a Spawning Water Profile

### Materials and Methods for Example 3

The General Materials and Methods of Example 1 were utilized except without a separator to separate the sexes of fish within the priming water profile. 10 males and 30 females were used from AB lab stock.

### Results for Example 3.

4500 embryos were produced while in the priming water profile. 2100 embryos were produced for the first 10 minutes within the spawning water profile. 300 embryos were produced in the 50 minutes following the first 10 minute collection. An additional 300 embryos were produced between the first and second hour.

### Example 4

### Zebrafish Will Spawn in the Afternoon

### Materials and Methods for Example 4.

The General Materials and Methods of Example 1 were utilized. Further, setup was performed at 7:00 or 8:00 am and embryo collection began at 2:00 pm of the same day. 10 males and 30 females were assessed.

### Results for Example 4.

250 embryos were produced during the day. 3000 embryos were produced during the first 10 minutes of introduction into the spawning water profile. An additional 150 embryos were produced between the first and second hour within the spawning water profile.

### Example 5

### Kit and Method Efficacy with a Strain of Zebrafish Known to be Difficult to Breed

### Material and Methods for Example 5.

The General Materials and Methods of Example 1 were utilized. A braf/p53 double mutant strain (15 males and 40 females) was used. Repeated trials of shallow to deep were then performed.

### Results for Example 5.

A total of 1800 embryos were collected after 30 minutes of trials within the spawning water profile.

### Example 6

### Rapid Collection of Large Numbers of Developmentally Staged Zebrafish Embryos

A number of features make the zebrafish (Danio rerio) an excellent experimental subject, particularly its high fecundity. A healthy, sexually mature female fish is capable of producing hundreds of offspring every day, and individual clutch sizes may exceed 700 embryos¹. This tremendous reproductive potential is unmatched by any other major vertebrate model organism and makes the zebrafish embryo/larva particularly suitable for use in studies where high rate of throughput and/or automation are advantageous. However, the prior art methods and equipment typically used to collect newly spawned zebrafish embryos in the laboratory do not allow this potential to be fully realized. The most common approach involves placing a small (typically 1-2 L) polycarbonate mating cage or insert with a mesh bottom inside a slightly larger container that is filled with water. Pairs of males and females or small mixed-sex groups (typically 5 fish total) are then added to the mating cage on the evening prior to the morning when embryos are desired. Male and female fish may be separated overnight by means of a small divider. The following morning, the divider is removed, allowing the fish to spawn. Newly fertilized embryos fall through the mesh “floor” of the insert to facilitate collection while protecting them from cannibalization by adults^{2,3}.

While this prior art is generally effective, the amount of time, space, and labor that it requires quickly proves limiting as to the quantity of developmentally synchronized embryos produced and thus limiting the size of experiment in which they can be used. This loss in efficiency creates a logistical barrier to large-scale experiments in terms of the number of embryos that can be collected at given time points, even though a population of fish may actually be capable of producing enough embryos to support a given study. Further difficulties arise when experiments necessitate that embryos to be at the same developmental stage for the purposes of treatment, manipulation, or analysis. To overcome these obstacles, we have developed a new method for spawning and embryo collection of zebrafish that centers around the employment of an innovative, specialized breeding vessel that capitalizes on the natural tendency of the fish to spawn in shallow water. The present invention provides the following advantages over the prior art: 1) the present invention enables the production and collection of very large numbers of embryos and 2) the present invention enables the user to precisely define when those embryos have been fertilized.

### Materials and Methods for Example 6.

Breeding Vessel and Operation.

The breeding vessel is comprised of three primary components: a vessel or tank, a spawning platform, and a separator (FIGS. 4-7D). The tank can be a clear acrylic, cylindrical 100 L tank with a cone-shaped bottom drained by a ball valve. The tank can sit inside and be supported by a stainless steel frame. The spawning platform can be a cylindrical polyethylene basket with a plastic mesh bottom that fits snugly inside the tank. The bottom or “floor” of the platform can be constructed to provide an undulating topography, with alternating high and low areas (FIGS. 6A-6C). The spawning platform can include a handle that allows it to be lowered or raised within the tank. The third major component of the breeding vessel is the separator, which can be a cylindrical, double layered plastic mesh insert designed to rest on the top lip of the spawning platform. The separator can also have a handle that allows it to be raised or lowered within the chamber.

During operation, the tank is filled with conditioned water. The spawning platform can be inserted into the tank and pushed down so that its bottom is flush with where the cone portion of the chamber extends from the base of the cylinder. Pre-sorted, adult female zebrafish can be transferred into the tank, so that they are swimming within the spawning platform cylinder. The separator can be inserted into the tank and pushed down so that it is seated on the top lip of the spawning platform, part-way down inside the tank. The females are then all contained within the first upper chamber 704, underneath the bottom of the separator (FIGS. 4A and 7A). Pre-sorted males can be added to the tank, so that they are swimming inside the second upper chamber 706, above the separator. When embryos are desired, the separator can be removed so that the males and females swim together in deep water. The platform can be immediately raised within the tank to a level where the water depth for the fish above the spawning platform is dramatically reduced (FIG. 5A-5C and 7B-7C). In this setting, the elevated areas of the undulated spawning platform floor are at or slightly above the water surface and the depressed areas are only 0.5″-3″ deep. Placing the spawning platform in this “shallow” physical arrangement immediately triggers spawning behavior in the fish. Newly fertilized embryos can fall through the openings of the mesh floor of the platform and rest at the bottom of the chamber. Spawning can be stopped at any time by removing the platform and the fish from the tank or lowering the spawning platform to provide a deep water profile. Embryos can be collected by opening the ball valve at the bottom of the chamber and draining the water into a sieve.

Animals.

Two different populations of wild type strain zebrafish (AB₁ and AB₂), and one population of a transgenic rps29 ribosomal mutant zebrafish (rps29^{hi2903Tg/+}) were used in the breeding vessel validation trials. The fish from the AB₁, AB₂, and rps29^{hi2903Tg/+} populations were 24, 18, and 10 months old at the time of the trials, respectively. The mean population size of each group was approximately 250 animals.

Animal Management and Conditioning.

The fish were maintained in a 4500 L recirculating aquaculture system (Aqua Schwarz GmbH, Gottingen, Germany). The animals from each population used in the trials were housed in mixed sex groups on the system in multiple 9 L holding tanks at an approximate density of 6-7 fish/L. Photoperiod was 15L:9D (light:dark), and the mean ranges for conductivity, pH, and temperature in the system were 1100-1300 μs, 7.5-8.0, and 26-29° C., respectively. Fish were fed to satiation 4× daily, 3× with Anemia franciscana nauplii (Artemia International LLC, Fairview, Tex., USA), and 1× with NRD 400-600 Pellet (INVE Aquaculture Inc., Salt Lake City, Utah, USA). Once a week, all fish from each population were removed from their tanks, pooled together and randomly redistributed back into tanks at the same densities to prevent dominance hierarchies potentially counterproductive to breeding success from being established.

Breeding Vessel Trials.

Fish from the three aforementioned populations were used in breeding vessel trials. Approximately 24 hours prior to each spawning event, 180 fish (100 males, 80 females) from a given population were sex segregated in the morning and returned back to the recirculating system (100 males in one tank, 80 females in two tanks) where they remained until set-up in the breeding vessel later in the afternoon. Eighteen hours prior to spawning, the outer chamber of the breeding vessel was filled with conditioned water (1100-1300 μS/pH 7.5-8.0/26-29° C.) from an off-system reserve tank and the fish were sequentially added to the chamber as previously described. In the morning on the following day, approximately 2 hours after the lights in the holding room came on, the breeding vessel was flushed with new, conditioned water from the off-system reserve tank to yield a 30% water change. The separator was removed immediately afterwards, allowing the males and females to swim together in deep water. The platform was then raised to the shallow water position and the fish were allowed to spawn for a 10-minute interval. The fish were then removed from the breeding vessel and the embryos were collected by opening the ball valve and draining the water in the vessel through a 200-micron mesh filter. The collected embryos were measured volumetrically (1 mL=600 embryos). After volumetric measurement, 100 embryos were randomly selected and reserved for 24 hours in a 50 mm petri dish to assess viability. The embryos that had developed normally up until that point were considered to be viable; those that had arrested or had undergone abnormal development were counted as non-viable.

This procedure, which required one person to complete, was repeated three times, once per week, for each population. During the trials with the fish from the AB₂ population, the procedure was timed, from start (sex segregation of test fish) to finish (collection of embryos).

Conventional Cross Comparison.

Comparative spawning trials with the zebrafish from the AB₂ population used in the breeding vessel trials were conducted in conventional 2.5 L static water spawning cages (Aqua Schwarz GmbH, Gottingen, Germany). 180 fish (100 males, 80 females) were sex-segregated as described above, in the morning, 24 hours prior to the trial. Approximately 18 hours prior to the trial, 40 cages were set up and filled with conditioned water from the off-system reserve tank and pre-sorted fish were added to them. Fish were added to spawning cages so that each contained either 2 males and 2 females or 3 males and 2 females. A divider was used to keep fish segregated in the cages overnight. The following morning, 18 hours after setup, (approximately 2 hours after the lights in the holding room came on) the tanks were arrayed onto the floor, and flushed with water from the off-system reserve tank, so that a 30% water change was achieved. Immediately afterwards, excess water was removed from the tanks to create a shallow water profile of approximately 15 mm deep. The dividers were then removed and the fish were allowed to spawn for one 10-minute interval. The fish were then removed from each spawning cage and all embryos were collected and measured volumetrically in the same manner described above. The embryos were assessed for viability in the same manner as described above. This procedure, which required two people to complete, was repeated three times, once per week, for this population. During each trial, the procedure was timed, from start (sex segregation of test fish) to finish (collection of embryos).

Embryo Production and Time Staging Trial.

100 fish (60 males, 40 females) from the AB₂ population were set up in a series of different crossing events to analyze the effects of cross type (breeding vessel vs. conventional 2.5 L static water spawning cage) and spawning interval (10 minutes, 1 hour, and 3 hours) on total embryo production and developmental synchronization of embryos. The fish used in this set of trials were sex-segregated in the morning, 24 hours prior to the trial. Approximately 18 hours prior to the trial, 15 males and 10 females were added to the breeding vessel in the same manner described previously. The remaining 75 fish were added to 15 conventional spawning cages in the same manner described previously, so that each contained 3 males and 2 females. The following morning, approximately 18 hours after set-up, again, following the same respective sequence of events described previously, all of the fish were allowed to spawn for 10 minutes (the breeding vessel, and 5 of the spawning cages), 1 hour (5 of the spawning cages) or 3 hours (5 of the spawning cages). Immediately after the completion of the spawning intervals, the fish were removed from the crosses, and the resultant embryos were collected and quantified volumetrically. One hundred viable embryos from each cross type were then randomly selected from each pool and reserved at room temperature in 50 mm petri dishes at a density of 50 embryos per dish. Six hours after the spawning intervals began, all of the embryos reserved in this manner were examined under a standard dissecting microscope and scored for developmental stage.

### Results for Example 6.

We tested this method using three separate populations of zebrafish; including two cohorts of a commonly used wild-type strain (AB₁ and AB₂), and one of all heterozygous carriers of a transgenic insertional mutation in the rps29 gene (rps29^{hi2903Tg/+}). In these trials, 100 male and 80 female fish from each population were set up in the breeding vessel and allowed to spawn for one 10-minute spawning interval. For each event, the total number of embryos produced during the spawning interval was measured volumetrically (1 mL=600 embryos) after collection and a randomly sampled subset (100) were reserved and assessed for viability 24 hours later. The AB₁, AB₂, and rps29^{hi2903Tg/+} fish produced mean per-interval clutch sizes of 8600±917, 8400±794, and 6800±1997 embryos, respectively (±.s.d., n=3). The mean viability of the collected embryos was 0.82±0.09, 0.86±0.006 and 0.61±0.25 for the AB₁, AB₂, and rps29^{hi2903Tg/+} fish, respectively (±.s.d., n=3). When we set up the same AB₂ fish in multiple conventional crosses, we found that our new method not only yielded significantly higher numbers of embryos, but also greatly reduced the time and space required to do so (Table 1). Further, because our apparatus allows us to precisely define when spawning and fertilization occurs, the embryos collected from such events are all at the same developmental time point. While conventional methods may be used to generate similarly time-staged events, as well as large numbers of embryos, it is not possible to achieve both at the same time with the same number of fish.

TABLE 1
Comparison between conventional crosses and breeding vessel

| | Conventional Crosses | Breeding Vessel |
|---|---|---|
| | (40) | (1) |
| | Average Time (minutes) | |
| Setup (day before) | 77 ± 6 | 22 ± 2 |
| Setup (morning of) | 13 ± 3 | 2 ± 1 |
| Breakdown | 5 ± 1 | 2 ± 1 |
| Embryo Collection | 27 ± 6 | 2 ± 0.6 |
| Total time | 122 ± 7.6 | 29 ± 2.6 |
| Space required (ft²) | 16.7 | 2.92 |
| Total embryos produced | 4234 ± 212^{a} | 8400 ± 794^{b} |
| Embryo viability (proportion) | 0.87 ± 0.02^{a} | 0.86 ± 0.006^{a} |

Data for time, total embryos produced, and embryo viability are mean ± standard deviation. For embryo production and viability values, means with different superscript letters within each row are significantly different (Student's t-test, p < 0.05).

This new method is an important advance that has the potential to greatly accelerate the pace and scale of certain types of experiments conducted using the zebrafish model system. For example, by using our breeding vessel in chemical genetic screens that we are currently conducting in our laboratory⁶, we have effectively reduced the average time it takes to screen a given library of compounds and completely eliminated phenotype-scoring problems arising from developmental asynchrony in the embryos. This approach should also serve to complement existing and future efforts to capitalize on the amenability of the zebrafish to high throughput manipulation, analysis and automation.

### Example 7

### Assessing an Embodiment of the Apparatus and Method with Respect to Various Strains of Zebrafish

General Materials and Methods for Example 7 with the Apparatus of Example 6.

The day prior to when embryos are desired, the main tank is filled with fresh uncirculated fish water. The spawning platform is pushed is pushed down towards the bottom of the main tank, maximizing volume and creating a priming water profile. Female zebrafish of the desired strain are added. The male/female separator is set on top of the spawning platform, temporarily trapping all the female fish. The thumbscrew is turned upwards until enough pressure is applied to the bottom of the spawning platform's handle, effectively sealing female fish and preventing the male/female separator from floating to the surface. Males are then added to the main tank and are physically separated from the females below by the separator.

When the embryos are desired, the thumbscrew is turned downwards until enough space is present to remove the male/female separator. The separator is tilted and removed within the chamber, allowing male fish to mix with females below. The water column is reduced to a shallower spawning water profile by lifting the spawning platform and resting the handle on top of the two arms, which extend from the steel frame. The ball valve at the bottom of the main tank is opened in order to drain excess water and creating the necessary water profile conducive to maximal spawning. Fish are kept in the spawning platform in this spawning profile position for the spawning intervals. At the end of the spawning interval all fish are transferred to a separate holding tank, and all the water from the main tank is drained out via the ball valve. A custom made embryo collector with 200 μm mesh sieve is placed on top of the drainage funnel to collect all embryos spawned during the spawning intervals. All embryos are transferred to a volumetric tube and measured by volume (approximately 1 mL=˜600 embryos).

### Particular Materials and Methods for Example 7.

Seven different strains of zebrafish from a total of nine separate pools of fish were assessed. In each trial, the ratio of male to female and the total number of fish was varied in order to establish the optimal condition for the highest yields. Fish were set up in the chamber overnight, and allowed to spawn for one ten minute interval on the following day. After the interval was over and the fish were removed, the chamber was drained and all embryos were collected and measured volumetrically (1 mL of settled embryos=˜600 embryos).

### Results for Experiment 7.

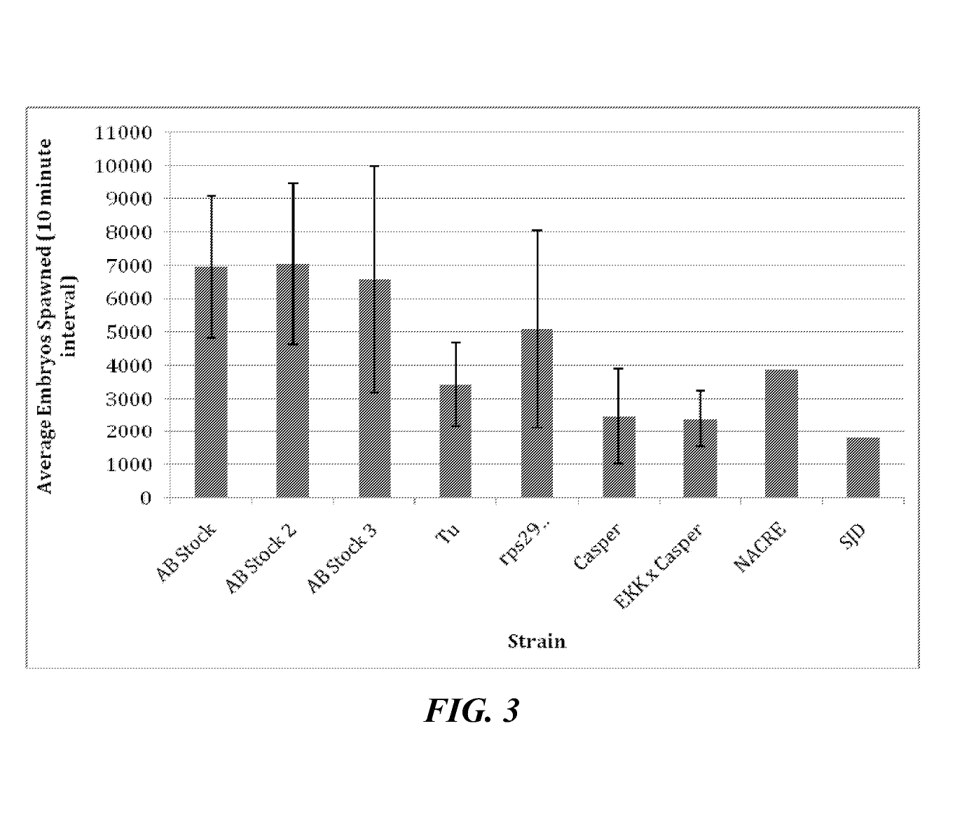

The average number of embryos collected per zebrafish strain ranged from a minimum of 1,200 to 10,500 (FIG. 3). The best ten trials for any strain ranged from 6,900 embryos to 10,500 embryos in ten minutes.

### Example 8

### Assessing an Embodiment of the Apparatus and Method while Varying Timing Conditions for Embryo Production

### Materials and Methods for Example 8.

The procedure was the same as in the General Materials and Methods for Example 7 while varying breeding conditions, as indicated in column headings, for thirty independent trials.

Results for Example 8.

Table 2 shows, for thirty trials, the strain of fish used in the trial, the approximate age of the fish in months, the number of males in the trial, the number of females in the trial, the number of total fish in the trial, and the total embryo production for all spawning intervals combined. Table 3 shows, for the same thirty trials, the time of set up on the day prior to the trial, the approximate interval in days between the last time the fish were set up in a spawning event, the percentage of water in the vessel that was flushed on the morning of the trial, the interval between the flushing and release time, the time of release (indicating when the separator was removed and the fish were moved to a spawning water profile for spawning), the duration of the first spawning interval in minutes (the amount of time fish were in the spawning water profile), and the number of embryos produced during the spawning interval, with the associated number of embryos per female. Table 4 shows, for the same thirty trials, the amount of time in minutes that fish were kept within the priming water profile between the first and second spawning intervals (if conducted), the percentage of water in the vessel that was flushed between the first and second spawning intervals, the number of embryos produced in the second spawning interval, the amount of time in minutes that fish were kept in the priming water profile between the second and third spawning intervals (if conducted), the duration of the third spawning interval (if conducted), the percentage of water in the vessel that was flushed between the second and third spawning intervals, and the number of embryos produced during the third spawning interval.

Data from these thirty trials indicates that one of ordinary skill can readily recognize and adjust numerous variables to optimize for a particular use or experiment. For example, the user can adjust the sex ratio to manage for timing and intensity of spawning.

TABLE 2
Data for the same thirty trials as Table 3 and Table 4, considering strain of the fish
used in the trial (Strain), approximate age of the fish in months (Approximate Age), the
number of males in the trial (# Males), the number of females in the trial (# Females), the
ratio of males to females in the vessel during the trial (M:F Ratio), and the total number of
fish in the trial (# Total embryos), and embryo production after as many as three spawning
events (# Total Embryos).

| | | Approximate | | | M:F | # Total | # Total |
|---|---|---|---|---|---|---|---|
| Trial | Strain | Age (months) | # Males | # Females | Ratio | Fish | Embryos |
| 1 | Insertional mutant bets | >12 | 69 | 76 | 0.91 | 145 | 10800 |
| 2 | AB | >12 | 185 | 75 | 2.47 | 260 | 9200 |
| 3 | Casper | 5 | 106 | 57 | 1.86 | 163 | 1800 |
| 4 | TU | 6 | 80 | 56 | 1.43 | 136 | 6600 |
| 5 | AB | >12 | 161 | 94 | 1.71 | 255 | 8700 |
| 6 | TU | >12 | 191 | 111 | 1.72 | 302 | 0 |
| 7 | TU | 6 | 80 | 58 | 1.38 | 138 | 4200 |
| 8 | AB | >12 | 111 | 67 | 1.66 | 178 | 6900 |
| 9 | EKK × Casper | 6 | 69 | 103 | 0.67 | 172 | 1800 |
| 10 | Nacre | 10 | 59 | 94 | 0.63 | 153 | 8700 |
| 11 | SJD | >12 | 111 | 49 | 2.27 | 160 | 1800 |
| 12 | Tu | 6 | 107 | 50 | 2.14 | 157 | 3700 |
| 13 | AB | >12 | 147 | 68 | 2.16 | 215 | 7800 |
| 14 | Casper | 5 | 128 | 68 | 1.88 | 196 | 6300 |
| 15 | Tu | 5 | 130 | 68 | 1.91 | 198 | 4200 |
| 16 | AB (new ISP stock) | 6 | 145 | 95 | 1.53 | 240 | 7200 |
| 17 | Casper | 5 | 153 | 68 | 2.25 | 221 | 3000 |
| 18 | AB | >12 | 115 | 80 | 1.44 | 195 | 12600 |
| 19 | AB | >12 | 130 | 94 | 1.38 | 224 | 13800 |
| 20 | AB (new isp stock) | 6 | 150 | 100 | 1.50 | 250 | 6600 |
| 21 | Tu | NA | 150 | 100 | 1.50 | 250 | 0 |
| 22 | Alison's Fish | >12 | 66 | 69 | 0.96 | 135 | 10200 |
| 23 | Casper | 5 | 132 | 78 | 1.69 | 210 | 4200 |
| 24 | AB | >12 | 130 | 95 | 1.37 | 225 | 6000 |
| 25 | Tu | 6 | 120 | 80 | 1.50 | 200 | 2000 |
| 26 | AB (new isp stock) | 6 | 130 | 110 | 1.18 | 240 | 10500 |
| 27 | Unreleased AB | NA | 130 | 110 | 1.18 | 240 | 9100 |
| 28 | AB (new isp stock) | 6 | 130 | 125 | 1.04 | 255 | 7800 |
| 29 | Casper | 6 | 141 | 79 | 1.78 | 220 | 4500 |
| 30 | AB | 7 | 140 | 120 | 1.17 | 260 | 6600 |

TABLE 3
Data for the same thirty trials as Table 2 and Table 4, considering the time of set up
on the day prior to the trial (Time set up), the approximate interval in days between the last
time the fish were set up in a spawning event (Approximate Interval Between Spawning), the
percentage of water in the vessel that was flushed on the morning of the trial (Flush), the
interval between flushing and the release time, the interval between the flushing and release
time (Interval Between Flush/Release), the time of release as indicating when the separator
was removed and the fish were moved to the spawning water profile (Release Time), and the
duration of the first spawning interval (First Interval), and embryo production/embryos
produced per female during first spawning interval (# Embryos/# Embryos per Female).

| | | | | | Interval | | | |
|---|---|---|---|---|---|---|---|---|
| | | | | | Between | | | |
| | Time set up | Approximate Interval | | | Flush/ | | First | # Embryos/ |
| | (day prior to | Between Spawning | | | Release | Release | Interval | # Embryos |
| Trial | event) | (days) | | Flush (%) | (min) | Time | (min) | per Female |
| 1 | 2:00 PM | >21 | days | 0% | NA | 7:35 AM | 10 | 3000/39 |
| 2 | 2:00 PM | <7 | days | 0 | NA | 7:35 AM | 10 | 3000/40 |
| 3 | 2:00 PM | 7 | days | 100 | 120 | 11:00 AM | 10 | 1200/21 |
| 4 | 2:00 PM | never, 7 | days | 5 | NA | 7:35 AM | 10 | 1800/32 |
| 5 | 2:00 PM | 7 | days | 100 | 1 | 7:50 AM | 10 | 6300/67 |
| 6 | 2:00 PM | 7 | days | 100 | NA | 7:50 AM | 10 | 0/0 |
| 7 | 2:00 PM | 7 | days | 20 | 20 | 8:10 AM | 10 | 4200/72 |
| 8 | 2:00 PM | 7 | days | 15 | 5 | 7:47 AM | 10 | 6900/103 |
| 9 | 2:00 PM | Never | | 15 | NA | 7:55 AM | 10 | 1800/17 |
| 10 | 2:00 PM | >30 | days | 25 | NA | 8:00 AM | 10 | 3900/41 |
| 11 | 8:00 AM | >90 | days | 0 | NA | 12:50 PM | 10 | 1800/37 |
| 12 | 2:00 PM | 7 | days | 75 | 25 | 8:11 AM | 10 | 3600/72 |
| 13 | 2:00 PM | 7 | days | 50 | 60 | 8:07 AM | 10 | 7800/115 |
| 14 | 2:00 PM | >7 | days | 75 | 60 | 8:05 AM | 10 | 1800/26 |
| 15 | 2:00 PM | >7 | days | 75 | NA | 10:30 AM | 10 | 4200/62 |
| 16 | 2:00 PM | Never | | 100 | 90 | 10:30 AM | 10 | 7200/76 |
| 17 | 2:00 PM | 7 | days | 25 | NA | 8:00 AM | 10 | 0/0 |
| 18 | 2:00 PM | 7 | days | >1 | NA | 7:50 AM | 10 | 9600/120 |
| 19 | 3:00 PM | 7 | days | 100 | NA | 11:50 AM | 10 | 9600/102 |
| 20 | 2:00 PM | 7 | days | 15 | NA | 8:00 AM | 10 | 6600/66 |
| 21 | 2:00 PM | 12 | days | 100 | 490 | 3:00 PM | 10 | 0/0 |
| 22 | 2:00 PM | >30 | days | 75% | 1 | 8:38 AM | 10 | 7200/104 |
| 23 | 3:00 AM | 15 | days | 100 | 60 | 11:00 AM | 10 | 2400/31 |
| 24 | 2:00 PM | 7 | days | 0 | NONE | 7:45 AM | 10 | 6000/63 |
| 25 | 2:00 PM | 7 | days | 50 | NONE | 7:45 AM | 10 | 2000/25 |
| 26 | 3:30 PM | 10 | days | 100 | 60 | 9:30 AM | 10 | 10500/95 |
| 27 | 5:00 PM | Never | | 100 | 1 | 8:36 AM | 10 | 9000/82 |
| 28 | 3:30 PM | 7 | days | 100 | 1 | 9:20 AM | 10 | 7800/62 |
| 29 | 3:30 PM | 18 | days | 100 | 60 | 10:00 AM | 10 | 4500/57 |
| 30 | 3:30 PM | 7 | days | 100 | NA | 9:00 AM | 10 | 6600/55 |

TABLE 4
Data for the same thirty trials as Table 2 and Table 3, considering the amount of
time in minutes that fish were kept in the priming water profile between the first and second
spawning intervals, if conducted (Break), the duration of the second spawning interval, if
conducted (Second Interval), the percentage of water in the vessel was flushed between the
first and second spawning intervals (Flush), the number of embryos produced in the second
spawning interval (# Embryos), the amount of time in minutes that fish were kept in the
priming water profile between the second and third spawning intervals, if conducted (Break),
the duration of the third spawning interval, if conducted (Third Interval), the percentage of
water in the vessel that was flushed between the second and third intervals (Flush), and the
number of embryos produced during the third spawning interval (# Embryos).

| | | | | | | Third | | |
|---|---|---|---|---|---|---|---|---|
| | | | | # | Break | Interval | | # |
| Trial | Break (min) | Second Interval (min) | Flush % | Embryos | (min) | (min) | Flush % | Embryos |
| 1 | 15 | 20 | 50 | 4800 | 40 | 60 | 100 | 3000 |
| 2 | 5 | 10 | 20 | 2000 | 45 | 180 | 100 | 4200 |
| 3 | 15 | 60 | 100 | 600 | NA | NA | NA | NA |
| 4 | 10 | 10 | 100 | 1800 | 60 | 10 | 100 | 3000 |
| 5 | 10 | 10 | 100 | 2400 | NA | NA | NA | NA |
| 6 | NA | NA | NA | NA | NA | NA | NA | NA |
| 7 | NA | NA | NA | NA | NA | NA | NA | NA |
| 8 | NA | NA | NA | NA | NA | NA | NA | NA |
| 9 | NA | NA | NA | NA | NA | NA | NA | NA |
| 10 | 10 | 10 | 80 | 3300 | 10 | 10 | 1 | 1500 |
| 11 | NA | NA | NA | NA | NA | NA | NA | NA |
| 12 | 10 | 0 | 100 | 100 | NA | NA | NA | NA |
| 13 | NA | NA | NA | NA | NA | NA | NA | NA |
| 14 | 10 | 10 | 100 | 2700 | 10 | 60 | 100 | 1800 |
| 15 | 10 | 10 | 100 | 0 | NA | NA | NA | NA |
| 16 | NA | NA | NA | NA | NA | NA | NA | NA |
| 17 | 120 | 10 | 100 | 3000 | NA | NA | NA | NA |
| 18 | 10 | 10 | 100 | 3000 | NA | NA | NA | NA |
| 19 | 10 | 10 | 100 | 1200 | 120 | 10 | 100 | 3000 |
| 20 | NA | NA | NA | NA | NA | NA | NA | NA |
| 21 | NA | NA | NA | NA | NA | NA | NA | NA |
| 22 | 26 | 10 | 100 | 3000 | NA | NA | NA | NA |
| 23 | 15 | 45 | 100 | 1800 | NA | NA | NA | NA |
| 24 | NA | NA | NA | NA | NA | NA | NA | NA |
| 25 | NA | NA | NA | NA | NA | NA | NA | NA |
| 26 | NA | NA | NA | NA | NA | NA | NA | NA |
| 27 | 90 | 10 | 100 | 100 | NA | NA | NA | NA |
| 28 | NA | NA | NA | NA | NA | NA | NA | NA |
| 29 | NA | NA | NA | NA | NA | NA | NA | NA |
| 30 | NA | NA | NA | NA | NA | NA | NA | NA |

1. A method for aquatic animal embryo production comprising:
providing a breeding tank containing a volume of water and a removable spawning platform positioned within the tank to define a first chamber of water below the spawning platform and a second chamber of water above the spawning platform, the spawning platform including a porous element that is permeable to the aquatic animal embryos and impermeable to aquatic animals producing the embryos;
positioning the spawning platform in the tank to provide a depth the second chamber of water above the spawning platform according to a priming water profile;
providing both sexes of the aquatic animal species in the second chamber of water;
positioning the spawning platform in the tank to provide a depth of the second chamber of water above the spawning platform according to a spawning water profile; and
collecting the embryos.

2. The method of claim 1 further comprising
putting one sex of the aquatic animal species in the second chamber;
providing a separator in the second chamber; and
putting the other sex of aquatic animal species in the second chamber, such that the separator prevents the aquatic animal species of different sexes from mingling.

3. The method of claim 2 wherein the separator includes a transparent material.

4. The method of claim 2 wherein the separator include a perforated material.

5. The method of claim 3 wherein the separator includes a perforated material.

6. The method of claim 2 wherein the separator includes a mesh material.

7. The method of claim 1 wherein at least a portion of the porous element has an undulating topography.

8. The method of claim 1 wherein the porous element includes a mesh material.

9. The method of claim 1 wherein the porous element include a perforated material.

10. The method of claim 1 wherein said aquatic animal species is a species of fish.

11. The method of claim 1 wherein said aquatic animal species is Danio rerio.

12. An apparatus for fish embryo production comprising;
a tank adapted for containing a volume of water;
a movable spawning platform positioned in the tank to divide the volume of water into a first chamber below the spawning platform and a second chamber above the spawning platform, the spawning platform including a porous element that is permeable to fish embryos and impermeable to fish producing the fish embryos.

13. The apparatus of claim 12 wherein the porous element includes a mesh material.

14. The apparatus of claim 12 wherein the porous element includes a perforated material.

15. The apparatus of claim 12 wherein at least a portion of the porous element has an undulating topography.

16. The apparatus of claim 12 wherein the movable spawning platform includes support elements; and
the support elements rest on a first portion of the tank and provide a water depth in the second chamber that corresponds to a priming water profile for the fish and
the support elements rest on a second portion of the tank and provide a shallow water depth in the second chamber that corresponds to a spawning water profile for the fish.

17. The apparatus of claim 12 wherein the tank includes a support frame and the movable spawning platform includes support elements; and
the support elements rest on the tank and provide a water depth in the second chamber that corresponds to a priming water profile for the fish and
the support elements rest on the support frame and provide a shallow water depth in the second chamber that corresponds to a spawning water profile for the fish.

18. The apparatus of claim 12 further comprising a removable separator adapted for dividing the second chamber above the spawning platform in an upper second chamber and a lower second chamber for sequestering one sex of the fish from the other sex until the initiation of spawning.

19. The apparatus of claim 16 wherein the removable separator includes a transparent material.

20. The apparatus of claim 16 wherein the removable separator include a perforated material.

21. The apparatus of claim 16 wherein the removable separator includes a mesh material.

22. The apparatus of claim 16 wherein the first chamber includes an embryo collector.

23. The apparatus of claim 12 wherein the fish are zebrafish and porous element is permeable to zebrafish embryos and impermeable to zebrafish.

24. A kit for fish embryo production comprising;
a first vessel of sufficient depth to create a priming water profile associated with the fish;
a second vessel of sufficient depth to create a spawning water profile associated with the fish; and
a spawning platform including a porous element that is embryo permeable, fish impermeable, the spawning platform being adapted to be positioned in the vessel according to priming water profile and the spawning water profile associated with the fish.

25. The kit of claim 24 further comprising a water permeable, fish impermeable separator adapted for sequestering each sex of the fish from the other sex while within the priming water profile.

26. The kit of claim 24 wherein the porous element includes an undulating topography.
